(19) United States
(12) Patent Application Publication
(10) Pub. No.: US 2021/0205845 A1
(43) Pub. Date: Jul. 8, 2021

(54) METHOD FOR PRODUCING A MULTI-LAYERED COATING

(71) Applicant: BASF Coatings GmbH, Münster (DE)

(72) Inventors: Cathrin Corten, Muenster (DE); Dirk Eierhoff, Muenster (DE); Patrick Wilm, Muenster (DE); Klaus-Juergen Kanngiesser, Muenster (DE); Joerg Schwarz, Muenster (DE)

(21) Appl. No.: 15/999,593

(22) PCT Filed: Feb. 19, 2016
(86) PCT No.: PCT/EP2016/053577

§ 371 Date: Aug. 17, 2018

(51) Int. Cl. B05D 7/00; B05D 1/00; B05D 7/14; C09D 5/44

(52) U.S. Cl. CPC B05D 7/577; B05D 1/007; B05D 7/14; C09D 5/4411; C09D 5/4423; C09D 5/4465; C09D 5/4461

(57) ABSTRACT

A method is disclosed for producing a multicoat paint system on a metallic substrate by producing a basecoat or a plurality of directly successive basecoats directly on a metallic substrate coated with a cured electrocoat system, producing a clearcoat directly on the one or the topmost of the plurality of basecoats, and subsequently jointly curing the one or the plurality of basecoats and the clearcoat. At least one basecoat material used for producing the basecoats includes at least one predispersed mixture including at least one polyamide having an acid number of less than 20 mg KOH/g, at least one polymeric resin different from the polyamide, and also water and at least one organic solvent.

The present invention relates to a method for producing a multicoat paint system by producing a basecoat or a plurality of directly successive basecoats directly on a metallic substrate coated with a cured electrocoat system, producing a clearcoat directly on the one or the topmost of the plurality of basecoats, and subsequently jointly curing the one or the plurality of basecoats and the clearcoat. The present invention further relates to a multicoat paint system produced by the method of the invention.

### PRIOR ART

Multicoat paint systems on metallic substrates, examples being multicoat paint systems in the automobile industry sector, are known. Starting, conceptually, from the metallic substrate, such multicoat paint systems generally comprise an electrocoat, a coat applied directly to the electrocoat and commonly referred to as primer-surfacer coat, at least one coat which comprises color and/or effect pigments and is generally referred to as a basecoat, and also a clearcoat.

The fundamental compositions and functions of the stated coats, and the coating compositions necessary to the construction of these coats, namely electrocoat materials, primer-surfacers, coating compositions that comprise color and/or effect pigments and are known as basecoat materials, and clearcoat materials, are known. For example, the electrophoretically applied electrocoat serves fundamentally to protect the substrate from corrosion. The primer-surfacer coat serves primarily to protect against mechanical exposure such as stone chipping, for example, and also to level out unevennesses in the substrate. The next coat, called the basecoat, is primarily responsible for producing esthetic qualities such as the color and/or effects such as the flop, while the clearcoat that then follows serves in particular for scratch resistance and also for gloss on the part of the multicoat paint system.

In the prior art these multicoat paint systems are produced by first applying or depositing an electrocoat material, more particularly a cathodic electrocoat material, electrophoretically on the metallic substrate, an automobile body, for example. The metallic substrate may undergo various pretreatments before the electrocoat material is deposited: for example, known conversion coatings such as phosphate coats, more particularly zinc phosphate coats, may be applied. The operation of depositing the electrocoat material takes place generally in corresponding electrocoating tanks. Following application, the coated substrate is removed from the tank, optionally rinsed and flashed and/or subjected to interim drying, and finally the applied electrocoat material is cured. The aim here is for coat thicknesses of around 15 to 25 micrometers. The primer-surfacer is then applied directly to the cured electrocoat, with optional flashing and/or interim drying, and subsequent curing. To allow the cured primer-surfacer coat to fulfill the functions identified above, coat thicknesses of 25 to 45 micrometers, for example, are the aim. Next, directly atop the cured primer-surfacer coat, a basecoat material is applied, comprising color and/or effect pigments, which is optionally flashed and/or subjected to interim drying, and a clearcoat material is applied directly to the thus-produced basecoat, without separate curing. The basecoat and the clearcoat, optionally likewise flashed and/or subjected to interim drying beforehand, are then jointly cured (wet-on-wet method). Whereas the cured basecoat in principle has comparatively low coat thicknesses of 10 to 20 micrometers, for example, the aim for the cured clearcoat is for coat thicknesses of 30 to 60 micrometers, for example, in order to attain the technological application properties described. Applying primer-surfacer, basecoat, and clearcoat materials can be done using, for example, the techniques of application, known to the skilled person, of pneumatic and/or electrostatic spray application. Primer-surfacer and basecoat materials are nowadays being used, simply for environmental reasons, increasingly in the form of aqueous coating materials.

Multicoat paint systems of these kinds, and methods for producing them, are described in, for example, DE 199 48 004 A1, page 17, line 37, to page 19, line 22, or else DE 100 43 405 C1, column 3, paragraph [0018], and column 8, paragraph [0052] to column 9, paragraph [0057], in conjunction with column 6, paragraph [0039] to column 8, paragraph [0050].

Although the multicoat paint systems produced accordingly may generally meet the requirements imposed by the automotive industry in terms of technological application properties and esthetic profile, the focus of the automakers nowadays is increasingly coming to rest, as a result of environmental and economic factors, on the simplification of the comparatively complex production operation described.

So there are approaches which attempt to do without the separate step of curing the coating composition applied directly to the cured electrocoat (that is, the coating composition referred to as primer-surfacer within the standard method described above), and at the same time, possibly, to lower the coat thickness of the coating film produced from this coating composition, as well. Within the art, this coating film, which is therefore not separately cured, is then frequently called the basecoat film (and no longer the primer-surfacer coat) or, to distinguish it from a second basecoat film applied atop it, it is called the first basecoat film. In some cases an attempt is even made to do entirely without this coating film (in which case, then, merely a so-called basecoat film is produced directly on the electrocoat film, over which, without a separate curing step, a clearcoat material is applied; in other words, ultimately, a separate curing step is likewise omitted). In place of the separate curing step and of an additional concluding curing step, then, the intention is to have merely one, concluding curing step following application of all of the coating films applied to the electrocoat film.

Avoiding a separate curing step for the coating composition applied directly to the electrocoat is very advantageous from environmental and economic aspects.

The reason is that it saves energy and allows the production operation as a whole to proceed with substantially less stringency, of course.

Instead of the separate curing step, then, it is an advantage for the coating produced directly on the electrocoat to be merely flashed at room temperature and/or subjected to interim drying at elevated temperatures, without carrying out curing which, as is known, regularly necessitates elevated curing temperatures and/or long curing times.

A problem, however, is that with this form of production, it is nowadays often not possible to obtain the requisite technological application properties and esthetic properties.

For instance, as a result of the absence of separate curing of the coating applied directly to the electrocoat, the first basecoat, for example, prior to the application of further coating compositions, such as a second basecoat material and a clearcoat material, for example, there may be unwanted inclusions of air, solvent and/or moisture, which may manifest themselves in the form of blisters beneath the surface of the overall paint system and may break open during the concluding cure. The holes which are formed as a result of this in the paint system, such holes also being called pinholes and pops, lead to a deleterious visual appearance. The amount of organic solvent and/or water arising as a result of the overall construction of first basecoat, second basecoat, and clearcoat material, and also the amount of air introduced through the application method, is too great for the entire amount to be able to escape from the multicoat paint system within a concluding curing step without defects being produced. In the case of a conventional production operation as described above, in which the primer-surfacer coat is baked separately prior to the production of a usually comparatively thin basecoat (which hence has only a comparatively low air, organic solvents and/or water content), the solution to this problem is of course much less demanding.

However, the problems described with pinholes and pops are also frequently encountered in the production of multicoat paint systems where the use of the coating composition identified as a primer-surfacer in the standard operation is forgone entirely, in other words systems in which, consequently, only a basecoat material is applied directly to the cured electrocoat. The reason is that, depending on the application and use of the multicoat paint system to be produced, in the case of complete absence of the coating referred to as a primer-surfacer coat in standard operation, the thickness of basecoat required is generally greater than that in the standard systems, in order to obtain the desired properties. In this case as well, therefore, the overall film thickness of coating films which must be cured in the concluding curing step is substantially higher than in standard operation.

Other relevant properties as well are not always satisfactorily achieved when multicoat paint systems are built up by way of the method described. For example, the attainment of a high-grade overall appearance, which is influenced in particular by effective leveling on the part of the coating compositions used, or the minimization of gel specks, represents a challenge. Here, the rheological properties of the coating compositions must be customtailored to the operating regime described.

In principle the use of any of a wide variety of rheological assistants for the purpose of adjusting the rheological properties is known.

For instance, EP 0 877 063 A2 discloses aqueous coating compositions which comprise as rheological assistant a polyamide which is typically used in aqueous compositions and which on the basis of its intended use in aqueous systems is distinguished by a comparatively high acid number of customarily greater than 30 mg KOH/g. Aqueous coating compositions which comprise such comparatively high acid-number polyamides used customarily in aqueous compositions are also known, furthermore from WO 2009/100938 A1 and EP 2 457 961 A1. A disadvantage, however, of the presence of a polyamide of this kind as a rheological assistant in aqueous coating composition is, in particular, the incidence of gel specks in the processing of an aqueous coating material of this kind in a method as described above.

Also known are aqueous coating compositions which comprise a metal silicate, employed customarily as rheological assistant in aqueous coating compositions, such as the commercially available metal silicate “Laponite® RD”, for example. Disadvantageous in this case, however, are the increased incidence of pinholes and/or poor leveling in processing by means of the method described above.

DE 40 28 386 A1 discloses aqueous coating compositions which comprise a polyamide as sole rheological assistant. The polyamide is added in the preparation of compositions as it is, in other words, in particular, not in the form of a mixture with further components.

Nothing is disclosed without the above-described specific production methods for multicoat paint systems and relevant requirements.

The use of polyamides with lower acid numbers per se as rheological assistants is known in principle, although in the prior art such polyamides are employed generally in solventborne coating compositions (those based on organic solvents).

### Problem and Technical Solution

It would therefore be advantageous to have a method for producing multicoat paint systems that removes the need for a separate curing step, as described above, for the coating composition applied directly to the electrocoat, with the multicoat paint system produced nevertheless having excellent technological application properties, more particularly esthetic properties. This is the very problem addressed by the present invention.

It has been found that the problems identified can be solved by means of a new method for producing a multicoat paint system (M) on a metallic substrate (S), comprising

(1) producing a cured electrocoat (E.1) on the metallic substrate (S) by electrophoretic application of an electrocoat material (e.1) to the substrate (S) and subsequent curing of the electrocoat material (e.1),

(2) producing (2.1) a basecoat (B.2.1) or (2.2) two or more directly successive basecoats (B.2.2.x) directly on the cured electrocoat (E.1) by (2.1) application of an aqueous basecoat material (b.2.1) directly to the electrocoat (E.1) or (2.2) directly successive application of two or more basecoat materials (b.2.2.x) to the electrocoat (E.1),

(3) producing a clearcoat (K) directly on (3.1) the basecoat (B.2.1) or (3.2) the topmost basecoat (B.2.2.x) by application of a clearcoat material (k) directly to (3.1) the basecoat (B.2.1) or (3.2) the topmost basecoat (B.2.2.x),

(4) jointly curing the (4.1) basecoat (B.2.1) and the clearcoat (K) or (4.2) the basecoats (B.2.2.x) and the clearcoat (K),

wherein

the basecoat material (b.2.1) or at least one of the basecoat materials (b.2.2.x) comprises at least one predispersed mixture (vdM), the mixture (vdM) comprising at least one polyamide (P) having an acid number of less than 20 mg KOH/g, at least one polymeric resin (H) different from the polyamide, and also water and at least one organic solvent.

The method specified above is also referred to below as method of the invention and is correspondingly a subject of the present invention. Preferred embodiments of the method of the invention are apparent from the description hereinafter and from the dependent claims.

A further subject of the present invention is a multicoat paint system produced by means of the method of the invention.

The method of the invention allows multicoat paint systems to be produced without a separate curing step for the coating produced directly on the electrocoat. For greater ease of comprehension, this coating for the purposes of the present invention is referred to as basecoat. Instead of separate curing, this basecoat is jointly cured together with optionally further basecoats beneath the clearcoat, and with the clearcoat. In spite of this, multicoat paint systems having outstanding technological application properties, more particularly esthetic properties, result from the application of the method of the invention.

A particular surprise was that it is possible, specifically through the use of a polyamide (P) having an acid number of less than 20 mg KOH/g in an aqueous basecoat material, and the use thereof in the method described above, to obtain the esthetic properties described, in other words positive effects on—in particular—gel specks, pinholes and leveling defects. It is in fact these polyamides which are customarily used in solventborne coating materials, on account of their hydrophobic character. But the problem is solved only when the polyamide is employed in the form of a predispersed specific mixture (vdM) in the preparation of the aqueous basecoat material.

### Comprehensive Description

First of all a number of terms used in the context of the present invention will be explained.

The application of a coating material to a substrate, and the production of a coating film on a substrate, are understood as follows. The coating material in question is applied such that the coating film produced therefrom is disposed on the substrate, but need not necessarily be in direct contact with the substrate.

For example, between the coating film and the substrate, there may be other coats disposed. In stage (1), for example, the cured electrocoat (E.1) is produced on the metallic substrate (S), but between the substrate and the electrocoat there may also be a conversion coating disposed, as described later on below, such as a zinc phosphate coat.

The same principle applies to the application of a coating material (b) to a coating film (A) produced by means of another coating material (a), and to the production of a coating film (B) on another coating film (A). The coating film (B) need not necessarily be in contact with the coating film (A), being required merely to be disposed above it, in other words on the side of the coating film (A) that is remote from the substrate.

In contrast to this, the application of a coating material directly to a substrate, or the production of a coating film directly on a substrate, is understood as follows. The coating material in question is applied such that the coating film produced therefrom is disposed on the substrate and is in direct contact with the substrate. In particular, therefore, there is no other coat disposed between coating film and substrate.

The same applies, of course, to the application of a coating material (b) directly to a coating film (A) produced by means of another coating material (a), and to the production of a coating film (B) directly on another coating film (A). In this case the two coating films are in direct contact, being therefore disposed directly on one another. In particular there is no further coat between the coating films (A) and (B). The same principle of course applies to directly successive application of coating materials and to the production of directly successive coating films.

Flashing, interim drying, and curing are understood in the context of the present invention to have the same semantic content as that familiar to the skilled person in connection with methods for producing multicoat paint systems.

The term “flashing” is understood accordingly in principle as a designation for the passive or active evaporation of organic solvents and/or water from a coating material applied as part of the production of a paint system, usually at ambient temperature (that is, room temperature), 15 to 35° C. for example, for a duration of 0.5 to 30 minutes, for example. Flashing is accompanied therefore by evaporation of organic solvents and/or water present in the applied coating material. Since the coating material is still fluid, at any rate directly after application and at the beginning of flashing, it may flow in the course of flashing. The reason is that at least one coating material applied by spray application is applied generally in the form of droplets and not in a uniform thickness. As a result of the organic solvents and/or water it comprises, however, the material is fluid and may therefore undergo flow to form a homogeneous, smooth coating film. At the same time, there is successive evaporation of organic solvents and/or water, resulting after the flashing phase in a comparatively smooth coating film, which comprises less water and/or solvent in comparison with the applied coating material. After flashing, however, the coating film is not yet in the service-ready state. While it is no longer flowable, for example, it is still soft and/or tacky, and possibly is only partly dried. In particular, the coating film is not yet cured as described later on below.

Interim drying is thus understood likewise to refer to the passive or active evaporation of organic solvents and/or water from a coating material applied as part of the production of a paint system, usually at a temperature increased relative to the ambient temperature and amounting, for example, to 40 to 90° C., for a duration of 1 to 60 minutes, for example. In the course of interim drying as well, therefore, the applied coating material will lose a fraction of organic solvents and/or water. Based on a particular coating material, the general rule is that interim drying, by comparison with flashing, proceeds for example at higher temperatures and/or for a longer time period, meaning that, by comparison with flashing, there is also a higher fraction of organic solvents and/or water that escapes from the applied coating film. Even interim drying, however, does not result in a coating film in the service-ready state, in other words not a cured coating film as described later on below. A typical sequence of flashing and interim drying would be, for example, the flashing of an applied coating film at ambient temperature for 3 minutes and then its interim drying at 60° C. for 10 minutes. A conclusive delimitation of the two concepts from one another, however, is neither necessary nor desirable. For the sake of pure comprehension, these terms are used in order to make it clear that variable and sequential conditioning of a coating film can take place, prior to the curing described below. Here, depending on the coating material, the evaporation temperature and evaporation time, greater or lesser fractions of the organic solvents and/or water present in the coating material may evaporate. It is even possible here, optionally, for a fraction of the polymers present as binders in the coating material to undergo crosslinking or interlooping with one another as described below. Both in flashing and in interim drying, however, the kind of service-ready coating film that is the case for the curing described below is not obtained. Accordingly, curing is unambiguously delimited from flashing and interim drying.

The curing of a coating film is understood accordingly to be the conversion of such a film into the service-ready state, in other words into a state in which the substrate furnished with the coating film in question can be transported, stored, and used in its intended manner. A cured coating film, then, is in particular no longer soft or tacky, but instead is conditioned as a solid coating film which, even on further exposure to curing conditions as described later on below, no longer exhibits any substantial change in its properties such as hardness or adhesion to the substrate.

As is known, coating materials may in principle be cured physically and/or chemically, depending on components present such as binders and crosslinking agents. In the case of chemical curing, consideration is given to thermochemical curing and actinic-chemical curing. Where, for example, a coating material is thermochemically curable, it may be self-crosslinking and/or externally crosslinking. The indication that a coating material is self-crosslinking and/or externally crosslinking means, in the context of the present invention, that this coating material comprises polymers as binders and optionally crosslinking agents that are able to crosslink with one another correspondingly. The parent mechanisms and also binders and crosslinking agents (film-forming components) that can be used are described later on below.

In the context of the present invention, “physically curable” or the term “physical curing” means the formation of a cured coating film by loss of solvent from polymer solutions or polymer dispersions, with the curing being achieved by interlooping of polymer chains. Coating materials of these kinds are generally formulated as one-component coating materials.

In the context of the present invention, “thermochemically curable” or the term “thermochemical curing” means the crosslinking of a coating film (formation of a cured coating film) initiated by chemical reaction of reactive functional groups, where the energetic activation of this chemical reaction is possible through thermal energy. Different functional groups which are complementary to one another can react with one another here (complementary functional groups), and/or the formation of the cured coat is based on the reaction of autoreactive groups, in other words functional groups which react among one another with groups of their own kind. Examples of suitable complementary reactive functional groups and autoreactive functional groups are known from German patent application DE 199 30 665 A1, page 7, line 28, to page 9, line 24, for example.

This crosslinking may be self-crosslinking and/or external crosslinking. Where, for example, the complementary reactive functional groups are already present in an organic polymer used as binder, as for example in a polyester, a polyurethane, or a poly(meth)acrylate, self-crosslinking occurs. External crosslinking occurs, for example, when a (first) organic polymer containing certain functional groups, hydroxyl groups for example, reacts with a crosslinking agent known per se, as for example with a polyisocyanate and/or a melamine resin. The crosslinking agent, then, contains reactive functional groups which are complementary to the reactive functional groups present in the (first) organic polymer used as binder.

In the case of external crosslinking in particular, the one-component and multicomponent systems, more particularly two-component systems, that are known per se are contemplated.

In thermochemically curable one-component systems, the components for crosslinking, as for example organic polymers as binders and crosslinking agents, are present alongside one another, in other words in one component. A requirement for this is that the components for crosslinking effectively react with one another—that is, enter into curing reactions—only at relatively high temperatures of more than 100° C., for example. Otherwise it would be necessary to store the components for crosslinking separately from one another and to mix them with one another only shortly before application to a substrate, in order to prevent premature at least proportional thermochemical curing (compare two-component systems). As an exemplary combination, mention may be made of hydroxy-functional polyesters and/or polyurethanes with melamine resins and/or blocked polyisocyanates as crosslinking agents.

In thermochemically curable two-component systems, the components for crosslinking, as for example the organic polymers as binders and the crosslinking agents, are present separately from one another in at least two components, which are not combined until shortly before application. This form is selected when the components for crosslinking effectively react with one another even at ambient temperatures or slightly elevated temperatures of 40 to 90° C., for example. As an exemplary combination, mention may be made of hydroxy-functional polyesters and/or polyurethanes and/or poly(meth)acrylates with free polyisocyanates as crosslinking agent.

It is also possible for an organic polymer as binder to have both self-crosslinking and externally crosslinking functional groups, and to be then combined with crosslinking agents.

In the context of the present invention, “actinic-chemically curable”, or the term “actinic-chemical curing”, refers to the fact that the curing is possible with application of actinic radiation, this being electromagnetic radiation such as near infrared (NIR) and UV radiation, more particularly UV radiation, and also particulate radiation such as electron beams for curing. The curing by UV radiation is initiated customarily by radical or cationic photoinitiators. Typical actinically curable functional groups are carbon-carbon double bonds, with radical photoinitiators generally being employed in that case. Actinic curing, then, is likewise based on chemical crosslinking.

Of course, in the curing of a coating material identified as chemically curable, there will always be physical curing as well, in other words the interlooping of polymer chains. The physical curing may even be predominant. Provided it includes at least a proportion of film-forming components that are chemically curable, nevertheless, a coating material of this kind is identified as chemically curable.

It follows from the above that according to the nature of the coating material and the components it comprises, curing is brought about by different mechanisms, which of course also necessitate different conditions at the curing stage, more particularly different curing temperatures and curing times.

In the case of a purely physically curing coating material, curing takes place preferably between 15 and 90° C. over a period of 2 to 48 hours. In this case, then, the curing differs from the flashing and/or interim drying, where appropriate, solely in the duration of the conditioning of the coating film. Differentiation between flashing and interim drying, moreover, is not sensible. It would be possible, for example, for a coating film produced by application of a physically curable coating material to be subjected to flashing or interim drying first of all at 15 to 35° C. for a duration of 0.5 to 30 minutes, for example, and then to be cured at 50° C. for a duration of 5 hours. Preferably, however, at least some of the coating materials for use in the context of the method of the invention, in other words electrocoat materials, aqueous basecoat materials, and clearcoat materials, are thermochemically curable, and especially preferably are thermochemically curable and externally crosslinking.

In principle, and in the context of the present invention, the curing of thermochemically curable one-component systems may be carried out preferably at temperatures of 100 to 250° C., preferably 100 to 180° C., for a duration of 5 to 60 minutes, preferably 10 to 45 minutes, since these conditions are generally necessary in order for chemical crosslinking reactions to convert the coating film into a cured coating film. Accordingly it is the case that a flashing and/or interim drying phase taking place prior to curing takes place at lower temperatures and/or for shorter times. In such a case, for example, flashing may take place at 15 to 35° C. for a duration of 0.5 to 30 minutes, for example, and/or interim drying may take place at a temperature of 40 to 90° C., for example, for a duration of 1 to 60 minutes, for example.

In principle, and in the context of the present invention, the curing of thermochemically curable two-component systems is carried out at temperatures of 15 to 90° C., for example, in particular 40 to 90° C., for a duration of 5 to 80 minutes, preferably 10 to 50 minutes. Accordingly it is the case that a flashing and/or interim drying phase occurring prior to curing takes place at lower temperatures and/or for shorter times. In such a case, for example, it is no longer sensible to make any distinction between the concepts of flashing and interim drying. A flashing or interim drying phase which precedes curing may take place, for example, at 15 to 35° C. for a duration of 0.5 to 30 minutes, for example, but at any rate at lower temperatures and/or for shorter times than the curing that then follows.

This of course is not to rule out a thermochemically curable two-component system being cured at higher temperatures. For example, in step (4) of the method of the invention as described with more precision later on below, a basecoat film or two or more basecoat films are cured jointly with a clearcoat film. Where both thermochemically curable one-component systems and two-component systems are present within the films, such as a one-component basecoat material and a two-component clearcoat material, for example, the joint curing is of course guided by the curing conditions that are necessary for the one-component system.

All temperatures elucidated in the context of the present invention should be understood as the temperature of the room in which the coated substrate is located. It does not mean, therefore, that the substrate itself is required to have the temperature in question.

The measurement methods to be employed in the context of the present invention for determining certain characteristic variables are evident from the Examples section. Unless explicitly indicated otherwise, these measurement methods are to be used for determining the respective characteristic variable.

Where reference is made in the context of the present invention to an official standard, without indication of the official validity period, the reference is of course to the version of the standard valid on the filing date or, if there is no valid version at that date, the most recent valid version.

### THE METHOD OF THE INVENTION

In the method of the invention, a multicoat paint system is built up on a metallic substrate (S).

Metallic substrates (S) contemplated essentially include substrates comprising or consisting of, for example, iron, aluminum, copper, zinc, magnesium, and alloys thereof, and also steel, in any of a very wide variety of forms and compositions. Preferred substrates are those of iron and steel, examples being typical iron and steel substrates as used in the automobile industry sector. The substrates themselves may be of whatever shape—that is, they may be, for example, simple metal panels or else complex components such as, in particular, automobile bodies and parts thereof.

Before stage (1) of the method of the invention, the metallic substrates (S) may be pretreated in a conventional way—that is, for example, cleaned and/or provided with known conversion coatings. Cleaning may be accomplished mechanically, for example, by means of wiping, sanding and/or polishing, and/or chemically by means of pickling methods, by incipient etching in acid or alkali baths, by means of hydrochloric or sulfuric acid, for example. Cleaning with organic solvents or aqueous cleaners is of course also possible. Pretreatment may likewise take place by application of conversion coatings, more particularly by means of phosphating and/or chromating, preferably phosphating. In any case, the metallic substrates are preferably conversion-coated, more particularly phosphatized, preferably provided with a zinc phosphate coat.

In stage (1) of the method of the invention, electrophoretic application of an electrocoat material (e.1) to the substrate (S) and subsequent curing of the electrocoat material (e.1) are used to produce a cured electrocoat (E.1) on the metallic substrate (S).

The electrocoat material (e.1) used in stage (1) of the method of the invention may be a cathodic or anodic electrocoat material. Preferably it is a cathodic electrocoat material. Electrocoat materials have long been known to the skilled person. They are aqueous coating materials which must be suitable for electrophoretic application to a metallic substrate. They comprise at any rate anionic or cationic polymers as binders. These polymers contain functional groups which are potentially anionic, meaning that they can be converted into anionic groups, carboxylic acid groups for example, or contain functional groups which are potentially cationic, meaning that they can be converted into cationic groups, amino groups for example. Conversion into charged groups is achieved generally through the use of corresponding neutralizing agents (organic amines (anionic), organic carboxylic acids such as formic acid (cationic)), with the anionic or cationic polymers then being produced as a result. The electrocoat materials generally and hence preferably further comprise typical anticorrosion pigments. The cathodic electrocoat materials that are preferred in the invention preferably comprise cationic polymers as binders, more particularly hydroxy-functional polyetheramines, which preferably have aromatic structural units. Such polymers are generally obtained by reaction of corresponding bisphenol-based epoxy resins with amines such as mono- and dialkylamines, alkanolamines and/or dialkylaminoalkylamines, for example. These polymers are used more particularly in combination with conventional blocked polyisocyanates. Reference may be made, by way of example, to the electrocoat materials described in WO 9833835 A1, WO 9316139 A1, WO 0102498 A1, and WO 2004018580 A1.

The electrocoat material (e.1) is therefore preferably an at any rate thermochemically curable coating material, and more particularly it is externally crosslinking. Preferably the electrocoat material (e.1) is a thermochemically curable one-component coating material. The electrocoat material (e.1) preferably comprises a hydroxy-functional epoxy resin as binder and a fully blocked polyisocyanate as crosslinking agent. The epoxy resin is preferably cathodic, more particularly containing amino groups.

Also known is the electrophoretic application of an electrocoat material (e.1) of this kind that takes place in stage (1) of the method of the invention. Application proceeds electrophoretically. This means that first of all the metallic workpiece for coating is immersed into a dipping bath comprising the coating material, and an electrical direct-current field is applied between the metallic workpiece and a counterelectrode. The workpiece therefore serves as the electrode; because of the described charge on the polymers used as binders, the nonvolatile constituents of the electrocoat material migrate through the electrical field to the substrate and are deposited on the substrate, producing an electrocoat film. In the case of a cathodic electrocoat material, for example, the substrate is connected accordingly as the cathode, and the hydroxide ions that form there as a result of the electrolysis of water carry out neutralization of the cationic binder, causing it to be deposited on the substrate and an electrocoat film to be formed. The method is therefore one of application by electrophoretic deposition.

Following the application of the electrocoat material (e.1), the coated substrate (S) is removed from the tank, optionally rinsed with water-based rinsing solutions, for example, then optionally subjected to flashing and/or interim drying, and lastly the applied electrocoat material is cured.

The applied electrocoat material (e.1) (or the applied, as yet uncured electrocoat film) is subjected to flashing at 15 to 35° C., for example, for a duration of 0.5 to 30 minutes, for example, and/or to interim drying at a temperature of preferably 40 to 90° C. for a duration of 1 to 60 minutes, for example.

The electrocoat material (e.1) applied to the substrate (or the applied, as yet uncured electrocoat film) is cured preferably at temperatures of 100 to 250° C., preferably 140 to 220° C., for a duration of 5 to 60 minutes, preferably 10 to 45 minutes, thereby producing the cured electrocoat (E.1).

The flashing, interim-drying, and curing conditions stated apply in particular to the preferred case where the electrocoat material (e.1) comprises a thermochemically curable one-component coating material as described above. This, however, does not rule out the electrocoat material being an otherwise-curable coating material and/or the use of different flashing, interim-drying, and curing conditions.

The film thickness of the cured electrocoat is, for example, 10 to 40 micrometers, preferably 15 to 25 micrometers. All film thicknesses reported in the context of the present invention should be understood as dry film thicknesses. It is therefore the thickness of the cured film in each case. Hence, where it is reported that a coating material is applied at a particular film thickness, this means that the coating material is applied in such a way as to result in the stated film thickness after curing.

In stage (2) of the method of the invention, (2.1) a basecoat film (B.2.1) is produced, or (2.2) two or more directly successive basecoat films (B.2.2.x) are produced. The films are produced by application (2.1) of an aqueous basecoat material (b.2.1) directly to the cured electrocoat (E.1), or by (2.2) directly successive application of two or more basecoat materials (b.2.2.x) to the cured electrocoat (E.1).

The directly successive application of two or more basecoat materials (b.2.2.x) to the cured electrocoat (E.1) therefore means that first of all a first basecoat material is applied directly to the electrocoat and thereafter a second basecoat material is applied directly to the film of the first basecoat material. An optional third basecoat material is then applied directly to the film of the second basecoat material. This procedure can then be repeated analogously for further basecoat materials (i.e., a fourth, fifth, etc. basecoat material).

After having been produced, therefore, the basecoat film (B.2.1) or the first basecoat film (B.2.2.x) is disposed directly on the cured electrocoat (E.1).

The terms basecoat material and basecoat film, in relation to the coating materials applied and coating films produced in stage (2) of the method of the invention, are used for greater ease of comprehension. The basecoat films (B.2.1) and (B.2.2.x) are not cured separately, but are instead cured jointly with the clearcoat material. Curing therefore takes place in analogy to the curing of basecoat materials employed in the standard process described in the introduction. In particular, the coating materials used in stage (2) of the method of the invention are not cured separately like the coating materials identified as primer-surfacers in the standard process.

The aqueous basecoat material (b.2.1) used in stage (2.1) is described in detail later on below. In a first preferred embodiment, however, it is at any rate thermochemically curable, and with more particular preference is externally crosslinking. The basecoat material (b.2.1) here is preferably a one-component coating material. The basecoat material (b.2.1) here preferably comprises a combination of at least one hydroxy-functional polymer as binder, selected from the group consisting of polyacrylates, polyurethanes, polyesters, and copolymers of said polymers, examples being polyurethane-polyacrylates, and also of at least one melamine resin as crosslinking agent.

Equally possible depending on the sector of use, and hence a second preferred embodiment, however, is the use of basecoat materials (b.2.1) which comprise only small amounts of less than 5 wt %, preferably less than 2.5 wt %, based on the total weight of the basecoat material, of crosslinking agents such as, in particular, melamine resins. Further preferred in this embodiment is for there to be no crosslinking agents present at all. In spite of this, an outstanding quality is achieved within the overall construction. An advantage of not using crosslinking agents, and of the consequently lower complexity of the coating material, lies in the increase in the formulating freedom for the basecoat material. The shelf life as well may be better, owing to the avoidance of possible reactions on the part of the reactive components.

The basecoat material (b.2.1) may be applied by the methods known to the skilled person for applying liquid coating materials, as for example by dipping, knifecoating, spraying, rolling, or the like. Preference is given to employing spray application methods, such as, for example, compressed air spraying (pneumatic application), airless spraying, high-speed rotation, electrostatic spray application (ESTA), optionally in conjunction with hot spray application such as hot air (hot spraying), for example. With very particular preference the basecoat material (b.2.1) is applied via pneumatic spray application or electrostatic spray application. Application of the basecoat material (b.2.1) accordingly produces a basecoat film (B.2.1), in other words a film of the basecoat material (b.2.1) that is applied directly on the electrocoat (E.1).

Following application, the applied basecoat material (b.2.1) or the corresponding basecoat film (B.2.1) is subjected to flashing at 15 to 35° C., for example, for a duration of 0.5 to 30 minutes, for example, and/or to interim drying at a temperature of preferably 40 to 90° C. for a duration of 1 to 60 minutes, for example.

Preference is given to flashing initially at 15 to 35° C. for a duration of 0.5 to 30 minutes, followed by interim drying at 40 to 90° C. for a duration of 1 to 60 minutes, for example. The flashing and interim-drying conditions described are applicable in particular to the preferred case where the basecoat material (b.2.1) is a thermochemically curable one-component coating material. This does not, however, rule out the basecoat material (b.2.1) being an otherwise-curable coating material, and/or the use of different flashing and/or interim-drying conditions.

Within stage (2) of the method of the invention, the basecoat film (B.2.1) is not cured, i.e., is preferably not exposed to temperatures of more than 100° C. for a duration of longer than 1 minute, and more preferably is not exposed at all to temperatures of more than 100° C. This is a direct and clear consequence of stage (4) of the method of the invention, which is described later on below. Since the basecoat film is cured only in stage (4), it cannot already be cured in stage (2), since in that case curing in stage (4) would no longer be possible.

The aqueous basecoat materials (b.2.2.x) used in stage (2.2) of the method of the invention are also described in detail later below. In a first preferred embodiment, at least one of the basecoat materials used in stage (2.2) is at any rate thermochemically curable, and with more particular preference is externally crosslinking. More preferably this is so for all basecoat materials (b.2.2.x). Preference here is given to at least one basecoat material (b.2.2.x) being a one-component coating material, and even more preferably this is the case for all basecoat materials (b.2.2.x). Preferably here at least one of the basecoat materials (b.2.2.x) comprises a combination of at least one hydroxy-functional polymer as binder, selected from the group consisting of polyacrylates, polyurethanes, polyesters and copolymers of the stated polymers, as for example polyurethane-polyacrylates, and also of at least one melamine resin as crosslinking agent. More preferably this is the case for all basecoat materials (b.2.2.x).

Also possible and hence likewise a preferred embodiment, depending on area of application, however, is to use at least one basecoat material (b.2.2.x) which comprises only small amounts of less than 5 wt %, preferably less than 2.5 wt %, of crosslinking agents such as melamine resins in particular, based on the total weight of the basecoat material. Even more preferred in this embodiment is for there to be no crosslinking agents included at all. The aforesaid applies preferably to all of the basecoat materials (b.2.2.x) used. In spite of this, an outstanding quality is achieved in the overall system. Other advantages are freedom in formulation and stability in storage.

Basecoat materials (b.2.2.x) can be applied by the methods known to the skilled person for applying liquid coating materials, such as by dipping, knifecoating, spraying, rolling or the like, for example. Preference is given to employing spray application methods, such as, for example, compressed air spraying (pneumatic application), airless spraying, high-speed rotation, electrostatic spray application (ESTA), optionally in conjunction with hot spray application such as hot air (hot spraying), for example. With very particular preference the basecoat materials (b.2.2.x) are applied via pneumatic spray application and/or electrostatic spray application.

In stage (2.2) of the method of the invention, the following designation is appropriate. The basecoat materials and basecoat films are labeled generally as (b.2.2.x) and (B.2.2.x), whereas the x may be replaced by other letters which match accordingly when designating the specific individual basecoat materials and basecoat films.

The first basecoat material and the first basecoat film may be labeled with a; the topmost basecoat material and the topmost basecoat film may be labeled with z. These two basecoat materials and basecoat films are present in any case in stage (2.2). Any films between them may be given serial labeling as b, c, d and so on.

Through the application of the first basecoat material (b.2.2.a), accordingly, a basecoat film (B.2.2.a) is produced directly on the cured electrocoat (E.1). The at least one further basecoat film (B.2.2.x) is then produced directly on the basecoat film (B.2.2.a). Where two or more further basecoat films (B.2.2.x) are produced, they are produced in direct succession. For example, there may be exactly one further basecoat film (B.2.2.x) produced, in which case this film is disposed directly beneath the clearcoat film (K) in the multicoat paint system ultimately produced, and may therefore be termed basecoat film (B.2.2.z) (see also FIG. 2). Also possible, for example, is the production of two further basecoat films (B.2.2.x), in which case the film produced directly on the basecoat (B.2.2.a) may be designated as (B.2.2.b), and the film arranged lastly directly beneath the clearcoat film (K) may be designated in turn as (B.2.2.z) (see also FIG. 3).

The basecoat material (b.2.2.x) may be identical or different. It is also possible to produce two or more basecoat films (B.2.2.x) with the same basecoat material, and one or more further basecoat films (B.2.2.x) with one or more other basecoat materials.

The basecoat materials (b.2.2.x) applied are generally subjected, individually and/or with one another, to flashing and/or interim drying. In stage (2.2), preferably, flashing takes place at 15 to 35° C. for a duration of 0.5 to 30 min and interim drying takes place at 40 to 90° C. for a duration of 1 to 60 min, for example. The sequence of flashing and/or interim drying of individual or of two or more basecoat films (B.2.2.x) may be adapted according to the requirements of the case in hand. The above-described preferred flashing and interim-drying conditions apply particularly to the preferred case wherein at least one basecoat material (b.2.2.x), preferably all basecoat materials (b.2.2.x), comprises thermochemically curable one-component coating materials. This does not rule out, however, the basecoat materials (b.2.2.x) being coating materials which are curable in a different way, and/or the use of different flashing and/or interim-drying conditions.

If a first basecoat film is produced by applying a first basecoat material and a further basecoat film is produced by applying the same basecoat material, then obviously both films are based on the same basecoat material. But application, obviously, takes place in two stages, meaning that the basecoat material in question, in the sense of the method of the invention, corresponds to a first basecoat material (b.2.2.a) and a further basecoat material (b.2.2.z). The system described is also frequently referred to as a one-coat basecoat film system produced in two applications. Since, however, especially in real-life production-line (OEM) finishing, the technical circumstances in a finishing line always dictate a certain time span between the first application and the second application, during which the substrate, the automobile body, for example, is conditioned at 15 to 35° C., for example, and thereby flashed, it is formally clearer to characterize this system as a two-coat basecoat system. The operating regime described should therefore be assigned to the second variant of the method of the invention.

A number of preferred variants of the basecoat film sequences for the basecoat materials (b.2.2.x) may be elucidated as follows.

It is possible to produce a first basecoat film by, for example, electrostatic spray application (ESTA) or pneumatic application of a first basecoat material directly on the cured electrocoat, to carry out flashing and/or interim drying thereon as described above, and subsequently to produce a second basecoat film by direct application of a second basecoat material, different from the first basecoat material. The second basecoat material may also be applied by electrostatic spray application or by pneumatic application, thereby producing a second basecoat film directly on the first basecoat film. Between and/or after the applications it is of course possible to carry out flashing and/or interim drying again. This variant of stage (2.2) is selected preferably when first of all a color-preparatory basecoat film, as described in more detail later on below, is to be produced directly on the electrocoat, and then a colorand/or effect-imparting basecoat film, as described in more detail later on below, is to be produced directly on the first basecoat film. The first basecoat film in that case is based on the color-preparatory basecoat material, the second basecoat film on the color- and/or effect-imparting basecoat material. It is likewise possible, for example, to apply this second basecoat material as described above in two stages, thereby forming two further, directly successive basecoat films, both based on the same basecoat material, directly on the first basecoat film.

It is likewise possible for three basecoat films to be produced in direct succession directly on the cured electrocoat, with the basecoat films being based on three different basecoat materials. For example, a color-preparatory basecoat film, a further film based on a color- and/or effect-imparting basecoat material, and a further film based on a second color- and/or effect-imparting basecoat material may be produced. Between and/or after the individual applications and/or after all three applications, it is possible in turn to carry out flashing and/or interim drying.

Embodiments preferred in the context of the present invention therefore comprise the production in stage (2.2) of the method of the invention of two or three basecoat films. In that case it is preferred for the basecoat film produced directly on the cured electrocoat to be based on a color-preparatory basecoat material. The second and any third film are based either on one and the same color- and/or effect-imparting basecoat material, or on a first colorand/or effect-imparting basecoat material and on a different second color- and/or effect-imparting basecoat material.

Within stage (2) of the method of the invention, the basecoat films (B.2.2.x) are not cured—that is, they are preferably not exposed to temperatures of more than 100° C. for a duration of longer than 1 minute, and preferably not to temperatures of more than 100° C. at all. This is evident clearly and directly from stage (4) of the method of the invention, described later on below. Because the basecoat films are cured only in stage (4), they cannot be already cured in stage (2), since in that case the curing in stage (4) would no longer be possible.

The basecoat materials (b.2.1) and (b.2.2.x) are applied such that the basecoat film (B.2.1), and the individual basecoat films (B.2.2.x), after the curing has taken place in stage (4), have a film thickness of, for example, 5 to 50 micrometers, preferably 6 to 40 micrometers, especially preferably 7 to 35 micrometers. In stage (2.1), preference is given to production of higher film thicknesses of 15 to 50 micrometers, preferably 20 to 45 micrometers. In stage (2.2), the individual basecoat films tend to have lower film thicknesses by comparison, the overall system then again having film thicknesses which lie within the order of magnitude of the one basecoat film (B.2.1). In the case of two basecoat films, for example, the first basecoat film (B.2.2.a) preferably has film thicknesses of 5 to 35, more particularly 10 to 30, micrometers, and the second basecoat film (B.2.2.z) preferably has film thicknesses of 5 to 35 micrometers, more particularly 10 to 30 micrometers, with the overall film thickness not exceeding 50 micrometers.

In stage (3) of the method of the invention, a clearcoat film (K) is produced directly (3.1) on the basecoat film (B.2.1) or (3.2) on the topmost basecoat film (B.2.2.z). This production is accomplished by corresponding application of a clearcoat material (k).

The clearcoat material (k) may be any desired transparent coating material known in this sense to the skilled person. “Transparent” means that a film formed with the coating material is not opaquely colored, but instead has a constitution such that the color of the underlying basecoat system is visible. As is known, however, this does not rule out the possible inclusion, in minor amounts, of pigments in a clearcoat material, such pigments possibly supporting the depth of color of the overall system, for example.

The coating materials in question are aqueous or solvent-containing transparent coating materials, which may be formulated not only as one-component but also as two-component or multicomponent coating materials. Also suitable, furthermore, are powder slurry clearcoat materials. Solventborne clearcoat materials are preferred.

The clearcoat materials (k) used may in particular be thermochemically curable and/or actinic-chemically curable. In particular they are thermochemically curable and externally crosslinking.

Typically and preferably, therefore, the clearcoat materials comprise at least one (first) polymer as binder, having functional groups, and at least one crosslinker having a functionality complementary to the functional groups of the binder. With preference at least one hydroxy-functional poly(meth)acrylate polymer is used as binder, and a free polyisocyanate as crosslinking agent.

Suitable clearcoat materials are described in, for example, WO 2006042585 A1, WO 2009077182 A1, or else WO 2008074490 A1.

The clearcoat material (k) is applied by the methods known to the skilled person for applying liquid coating materials, as for example by dipping, knifecoating, spraying, rolling, or the like. Preference is given to employing spray application methods, such as, for example, compressed air spraying (pneumatic application), and electrostatic spray application (ESTA).

The clearcoat material (k) or the corresponding clearcoat film (K) is subjected to flashing and/or interim-drying after application, preferably at 15 to 35° C. for a duration of 0.5 to 30 minutes. These flashing and interim-drying conditions apply in particular to the preferred case where the clearcoat material (k) comprises a thermochemically curable two-component coating material. But this does not rule out the clearcoat material (k) being an otherwise-curable coating material and/or other flashing and/or interim-drying conditions being used.

The clearcoat material (k) is applied in such a way that the clearcoat film after the curing has taken place in stage (4) has a film thickness of, for example, 15 to 80 micrometers, preferably 20 to 65 micrometers, especially preferably 25 to 60 micrometers.

In the method of the invention, of course, there is no exclusion of further coating materials, as for example further clearcoat materials, being applied after the application of the clearcoat material (k), and of further coating films, as for example further clearcoat films, being produced in this way. Such further coating films are then likewise cured in the stage (4) described below. Preferably, however, only the one clearcoat material (k) is applied, and is then cured as described in stage (4).

In stage (4) of the method of the invention there is joint curing (4.1) of the basecoat film (B.2.1) and of the clearcoat film (K) or (4.2) of the basecoat films (B.2.2.x) and of the clearcoat film (K).

The joint curing takes place preferably at temperatures of 100 to 250° C., preferably 100 to 180° C., for a duration of 5 to 60 minutes, preferably 10 to 45 minutes. These curing conditions apply in particular to the preferred case wherein the basecoat film (B.2.1) or at least one of the basecoat films (B.2.2.x), preferably all basecoat films (B.2.2.x), are based on a thermochemically curable one-component coating material. The reason is that, as described above, such conditions are generally required to achieve curing as described above for a one-component coating material of this kind. Where the clearcoat material (k), for example, is likewise a thermochemically curable one-component coating material, the corresponding clearcoat film (K) is of course likewise cured under these conditions. The same is evidently true of the preferred case wherein the clearcoat material (k) is a thermochemically curable two-component coating material.

The statements made above, however, do not rule out the basecoat materials (b.2.1) and (b.2.2.x) and also the clearcoat materials (k) being otherwise-curable coating materials and/or other curing conditions being used.

The result after the end of stage (4) of the method of the invention is a multicoat paint system of the invention (see also FIGS. 1 to 3).

The Basecoat Materials for Inventive Use

The basecoat material (b.2.1) comprises a specific predispersed mixture (vdM). This mixture comprises at least one polyamide (P) having an acid number of less than 20 mg KOH/g, at least one polymeric resin (H) different from the polyamide, and also water and at least one organic solvent. The stated components are described later on below.

The mixture (vdM) is predispersed. Moreover, the basecoat material (b.2.1) comprises this predispersed mixture. This therefore means that the components which the mixture (vdM) is to comprise on its completion are dispersed into this same mixture before the mixture as such is added as part of the preparation of the basecoat material. It is therefore essential to the invention that the mixture (vdM) is added as such. The wording “the basecoat material comprises the predispersed mixture” is therefore synonymous with the wording “the predispersed mixture is used as such in the preparation of the basecoat material”.

Preparation of the basecoat material (b.2.1) accordingly comprises the following steps: (i) dispersing the components which the mixture (vdM) is to comprise, before these components are brought into contact with the other constituents of the basecoat material (in other words predispersion). (ii) adding the predispersed mixture (vdM) to the otherwise completed basecoat material (b.2.1), or introducing the mixture (vdM) and adding the further constituents of the basecoat material (b.2.1), or adding the mixture (vdM) to a portion of the further constituents of the basecoat material (b.2.1) and adding the remaining part of the further constituents of the basecoat material (b.2.1).

The expression “dispersing” (or “predispersing”) should be understood as follows, drawing on the common knowledge familiar to the skilled person. It concerns the conversion of a mixture of different components, of which at least some are not completely miscible with one another and which therefore form different phases on simply being combined, into a macroscopically homogenized form. The term “dispersing” here is understood as a generic form of homogenization of inherently immiscible phases, thus including, for example, solid/liquid and liquid/liquid systems.

Of course, it is possible or necessary, according to the components present, for a certain microscopic phase separation to be present in the mixture after dispersing. The reason is that as well as having a fundamentally possible molecularly dissolved character, a mixture may also have emulsion character, for example.

The terms “macroscopic” and “microscopic” here evidently represent a phase separation or homogenization that is visible to the eye or not visible.

The way in which dispersing takes place in an individual instance is known and may be determined optionally by simple target-oriented tests (see also Examples). In general, dispersing is accomplished by introducing energy into a mixed system, thereby successively reducing the size of the droplets of the various phases, and so successively enlarging the boundary between the two phases. When the interfacial tension is overcome or an enlarged boundary is created, energy is required. This energy is generally introduced mechanically, more particularly via shearing forces. The shearing forces are generally introduced via the stirring of the system, in typical stirring assemblies such as a dissolver, for example.

Dispersing is typically effective when stirring speed and rate of addition and also sequence of addition of the components are harmonized with one another so that even temporary macroscopic phase separation does not occur, and instead a macroscopically homogenized form is present within the system throughout the preparation time. This is therefore preferred for the predispersing of the mixture (vdM). Although some phase separation may occur during storage subsequent to the dispersing, the system can easily be reagitated again into a homogeneous form. Dispersing takes place preferably such that a toroidal flow pattern is established, in other words what is called a donut effect (doughnut effect). This term is known to the skilled person. Predispersing or the production of a predispersed mixture may take place also, for example, with addition of typical auxiliaries (additives). These include, in particular, typical surface-active additives (emulsifiers) that are described in more detail later on below. The use of such additives is preferred in the context of the present invention. Likewise possible is the use of defoamers, which are known per se and which are able to suppress foaming that is possible as a result of the introduction of energy.

Two components of the mixture (vdM) are in any case the polyamide (P) and water. On the basis of its low acid number, in particular, the polyamide is not soluble in water. For this reason, it cannot be converted into a macroscopically homogeneous mixture (vdM) with water without the predispersing described. Accordingly, the polyamide (P) as such can also not be effectively integrated into the aqueous basecoat material (b.2.1). Direct addition during preparation of the basecoat material results in incompatibilities, which lead to gel specks, for example, in the coating ultimately produced. It was all the more surprising that the addition in the form of the predispersed mixture results in such excellent esthetic properties on the part of the resultant multicoat paint system. Therefore, in the systems of the invention based on waterborne coating materials, the polyamide, intended per se for coating materials based on organic solvents, exhibits excellent activity as a rheological assistant.

It is assumed that the polymeric resin (H) and the organic solvents, as components of the mixture, have a dispersing activity and therefore support or even actually enable predispersing to take place. This effect may of course be further supported by the emulsifiers already described above.

The mixture (vdM) is predispersed preferably at a temperature in the range from 15 to 30° C. over a time of to 60 minutes, preferably over a time of 5 to 30 minutes. Dispersing may take place by means of standard apparatus, especially dissolvers, such as using the “Dispermat® LC30” device from VWA-Getzmann, Germany. Such devices typically have a stirring disk (toothed disk) located in a stirring vessel. The relative size ratio of the diameter of the stirring disk to the diameter of the stirring vessel is preferably in a range from 1:1.1 to 1:2.5. The peripheral speed of the stirring disk when predispersing is carried out is preferably in a range from 15 to 25 m/s, more preferably from 15 to 20 m/s. The fill level of the stirring vessel is preferably in a range from 60% to 90%, based on the overall height of the stirring vessel. The diameter of the stirring disk is preferably greater than the distance of the stirring disk from the bottom of the stirring vessel.

The mixture (vdM) may comprise different amounts and types of polyamide (P), polymeric resins (H), and organic solvents, and also different amounts of water. The components can easily be tailored to one another by the skilled person in order then to obtain a macroscopically homogeneous (that is, predispersed) mixture. As polymeric resin (H) it is advantageous, for example, to use a resin which is in any case to be integrated into the aqueous basecoat material, as binder or crosslinking agent. In this way, a greater freedom of formulation is obtained.

The polyamide (P) has an acid number of less than 20 mg KOH per g. The polyamide (P) preferably has an acid number of less than 15 mg KOH per g, more preferably of less than 10 mg KOH per g, very preferably of less than 8 mg KOH per g, and even more preferably of S 7 mg KOH per g.

Polyamide (P) preferably has an acid number in a range from 0 to less than 20.0 mg KOH per g, more preferably in a range from 0.1 to less than 15.0 mg KOH per g, very preferably in a range from 0.1 to less than 10.0 mg KOH per g, and more preferably in a range from 0.1 to less than 8.0 mg KOH per g. In a further preferred embodiment the polyamide (P) has an acid number in a range from 0.1 to less than 10 mg KOH per g, more preferably in a range from 0.1 to 9 mg or from 0.5 to 9 mg KOH per g, very preferably in a range from 0.1 to 8 mg or from 0.5 to 8 mg KOH per g, especially preferably in a range from 0.1 to ≤7 mg or from 0.5 to 7 mg KOH per g. The acid number is determined in accordance with the method described later on below.

Any customary polyamide known to the skilled person may be used, provided it has an acid number of less than 20 mg KOH per g. The polyamide in question may be a polyamide homopolymer or copolymer. A mixture of two or more different polyamides (P) may also be used.

The polyamide (P) preferably has an amine number of less than 9 mg KOH per g, more preferably of less than 8 mg KOH per g, very preferably of ≤7 mg KOH per g. The polyamide used as polymeric resin (P1) preferably has an amine number in a range from 0.1 to less than 10 mg KOH per g, more preferably in a range from 0.1 to 9 mg or from 0.5 to 9 mg KOH per g, very preferably in a range from 0.1 to 8 mg or from 0.5 to 8 mg KOH per g, especially preferably in a range from 0.1 to ≤7 mg or from 0.5 to ≤7 mg KOH per g. The skilled person is aware of methods for determining the amine number. The amine number is preferably determined in accordance with DIN 16945 (date: March 1989).

The polyamide (P) preferably has a number-average molecular weight in a range from 100 g/mol to 5000 g/mol, more preferably in a range from 150 g/mol to 4000 g/mol, very preferably in a range from 200 g/mol to 3000 g/mol, especially preferably in a range from 250 g/mol to 2000 g/mol, most preferably in a range from 400 g/mol to 1500 g/mol. The skilled person is aware of methods for determining the number-average molecular weight. The number-average molecular weight is determined by the method described later on below.

The polyamide (P) is preferably obtainable by reaction of at least one polycarboxylic acid (C1a) with at least one polyamine (C1b), optionally in the presence of at least one monocarboxylic acid, more particularly at least one C₁₂-C₂₄ monocarboxylic acid, and/or at least one monoamine such as a C₂-C₁₂ monoamine, for example.

The polyamide (P) is preferably obtainable by reaction of at least one polycarboxylic acid (C1a) selected from the group consisting of aliphatic C₃-C₂₂ dicarboxylic acids, polymers such as dimers and trimers of aliphatic C₁₂-C₂₄ monocarboxylic acids, and mixtures thereof, with at least one aliphatic C₂-C₁₂ diamine (C1b).

The reaction of at least one polycarboxylic acid (C1a) and at least one polyamine (C1b) is carried out preferably in a preferably organic solvent.

The polyamide (P) is preferably obtainable by reaction of at least one polycarboxylic acid (C1a), preferably at least one polycarboxylic acid selected from the group consisting of aliphatic C₃-C₂₂ dicarboxylic acids, polymers such as dimers and trimers of aliphatic C₂-C₂₄ monocarboxylic acids, and mixtures thereof, with at least one polyamine (C1b), preferably of at least one aliphatic C₂-C₁₂ diamine (C1b), in which case the reaction product then obtained is optionally reacted thereafter with at least one monoamine and/or one monocarboxylic acid, in order hereby to adjust the acid number and also, optionally, the amine number.

Polyamides (P) are available commercially. Examples include the commercially available products Thixatrol® P220X-MF, Disparlon® A6900-20X, Disparlon® A650-20X, Disparlon® A670-20M, Disparlon F-9030, Luvotix® AB, Luvotix® PA 20 XA, Luvotix® R-RF, Luvotix® HT-SF, Luvotix® HAT 400, Luvotix® HT, Troythix® 250 XF, Byk-430, and Byk-431.

Polymeric resins (H) contemplated are the resins known in this context to the skilled person. Depending on the particular instance, suitable resins may be the relevant (co)polymers of ethylenically unsaturated monomers, polyaddition resins and/or polycondensation resins. Examples of suitable (co)polymers are (meth)acrylate (co)polymers or partially hydrolyzed polyvinyl esters, especially (meth)acrylate copolymers. Examples of suitable polyaddition resins and/or polycondensation resins are polyesters, alkyds, polyurethanes, polylactones, polycarbonates, polyethers, epoxy resins, epoxy resin-amine adducts, amino resins such as melamine resins, polyureas, polyamides, polyimides, polyester-polyurethanes, polyether-polyurethanes or polyester-polyether polyurethanes. The resin component and its fraction in the mixture (vdM) may be brought into line with the further components and their fractions by the skilled person, according to the particular instance, in order then to give a macrosopically homogeneous (i.e., predispersed) mixture.

Preferred polymeric resins (H) are polyesters, especially those having an acid number in a range from 20 to 50 mg KOH per g and an OH number in a range from 20 to 300 mg KOH per g.

More preferably the polyesters have an acid number in a range from 20 to 45 mg KOH per g, very preferably in a range from 25 to 40 mg KOH per g, especially preferably in a range from 30 to 38 mg KOH per g.

The polyesters more preferably have an OH number in a range from 25 to 250 mg KOH per g, very preferably in a range from 25 to 200 mg KOH per g, especially preferably in a range from 25 to 150 mg KOH per g, or in a range from 30 to 120 mg KOH per g. The OH number is determined by the method described later on below.

The polyesters preferably have a number-average molecular weight in a range from 500 g/mol to 100 000 g/mol, more preferably in a range from 700 g/mol to 90 000 g/mol, very preferably in a range from 1000 g/mol to 80 000 g/mol, especially preferably in a range from 1000 g/mol to 60 000 g/mol or in a range from 2000 g/mol to 60 000 g/mol or in a range from 2000 g/mol to 50 000 g/mol, most preferably in a range from 2000 g/mol to 10 000 g/mol or in a range from 2000 g/mol to 6000 g/mol.

In one preferred embodiment the polyester is at least obtainable by reaction of at least one polymerized aliphatic C₁₂-C₂₄ monocarboxylic acid with at least one diol and/or polyol. The polyester in question may be a polyester homopolymer or copolymer. The term “at least obtainable” is understood in this context in the sense of the present invention to mean that as well as the at least one polymerized aliphatic C₁₂-C₂₄ monocarboxylic acid and the at least one diol and/or polyol there may also, optionally, be further starting components used for preparing the polyester (P2), such as, for example, at least one aliphatic C₁₂-C₂₄ monocarboxylic acid and/or such as at least one dicarboxylic acid and/or at least one tricarboxylic acid, selected from the group consisting of aliphatic C₃-C₁₂ dicarboxylic acids, cycloaliphatic C₅-C₁₂ dicarboxylic acids, aromatic C₈-C₁₂ dicarboxylic acids, aliphatic C₅-C₁₂ tricarboxylic acids, cycloaliphatic C₅-C₁₂ tricarboxylic acids, and aromatic C₉-C₁₂ tricarboxylic acids. Lactones or hydroxycarboxylic acids should also be stated.

The term “polymerized aliphatic C₁₂-C₂₄ monocarboxylic acid” refers in the sense of the present invention preferably to a polymer, more particularly a dimer and/or trimer, of an aliphatic C₁₂-C₂₄ monocarboxylic acid. This term is known to the skilled person.

The skilled person is also aware of preparation methods for providing polymers, especially dimers and trimers, of aliphatic C₁₂-C₂₄ monocarboxylic acids, in other words for the provision of polymerized aliphatic C₁₂-C₂₄ monocarboxylic acids, such as, for example, dimerized, trimerized and/or more highly polymerized, more particularly dimerized and/or trimerized, aliphatic C₁₂-C₂₄ monocarboxylic acids from DE 25 60 211 A1, U.S. Pat. Nos. 2,793,219 A and 2,955,121 A, for example. The polymerized aliphatic C₁₄-C₂₂ monocarboxylic acids may optionally be substituted one or more times, as for example two, three, four or five times, preferably by at least one substituent selected from the group consisting of OH, O—C₁₋₄ aliphatic radicals, ═O, NH₂, NH(C₁₋₄ aliphatic radicals), N(C₁₋₄ aliphatic radicals), the substitution being on the same or on different carbon atoms. Starting materials used for preparing such polymerized aliphatic C₁₂-C₂₄ monocarboxylic acids comprise at least monounsaturated aliphatic C₁₂-C₂₄ monocarboxylic acids. The polymerized, such as dimerized and trimerized, aliphatic C₁₂-C₂₄ monocarboxylic acids obtained may in each case be isolated by distillation from one another and also in each case from higher polymerization products, and may be subjected optionally to further conversion reactions such as hydrogenations, for example.

The at least one polymerized aliphatic C₁₂-C₂₄ monocarboxylic acid used in preparing the polyester is preferably a dimerized and/or trimerized, more particularly at least one dimerized, C₁₂-C₂₄ monocarboxylic acid. A dimerized monocarboxylic acid is therefore in particular a dicarboxylic acid.

Polymerized, especially dimerized and trimerized C₁₂-C_{24 monocarboxylic acids are available commercially. Examples of commercial dimerized fatty acids are the products Empol} 1003, Empol 1005, Empol 1008, Empol 1012, Empol 1016, Empol 1026, Empol 1028, Empol 1061, Empol 1062, Pripol 1006, Pripol 1009, Pripol 1012, Pripol 1013, Pripol 1017, Pripol 1022, Pripol 1025, Pripol 1027 from Croda and examples of commercially available trimerized fatty acids are the products Empol 1043 from BASF and Pripol 1040 from Croda.

The polyester is preferably at least obtainable by reaction of at least one aliphatic polymerized, preferably at least one dimerized and/or trimerized, aliphatic C₁₂-C₂₄ monocarboxylic acid and optionally at least one aliphatic C₁₂-C₂₄ monocarboxylic acid with at least one C₂-C₂₀ polyol and/or C₂-C₂₀ diol.

The structural units obtainable from the at least one polymerized aliphatic C₁₂-C₂₄ monocarboxylic acid used in preparing the polyester employed as polymeric resin (P2) are preferably present in the polyester in an amount in a range of 10 to 80 mol %, preferably 10 to 60 mol %, more preferably 10 to 40 mol %, based on the total weight of the polyester. To a skilled person it is clear here that the polymerized aliphatic C₁₂-C₂₄ monocarboxylic acid used is not integrated completely into the polyester, but that in the reaction of the at least one polyol and/or diol with the at least one polymerized aliphatic C₁₂-C₂₄ monocarboxylic acid the structural units present in the polyester are only constructed on elimination of water as a result of the formation of ester bonds. With particular preference the at least one polymerized aliphatic C₁₂-C₂₄ monocarboxylic acid used in preparing the polyester employed as polymeric resin (P2) is a dimerized and/or trimerized C₁₂-C₂₄ monocarboxylic acid, and the structural unit obtainable from it is present in the polyester in an amount in a range from 12 to 38 mol %, very preferably in a range from 14 to 36 mol % or in a range from 16 to 34 mol % or in a range from 18 to 32 mol % or in a range from 20 to 30 mol % or in a range from 22 to 28 mol %, especially preferably in a range from 23 to 26 mol %, based in each case on the total weight of the polyester.

The further starting compounds which can be utilized for preparing polyesters, such as polyols such as diols, or further dicarboxylic acids, or monocarboxylic acids, or else lactones and hydroxycarboxylic acids, for example, are known to the skilled person and require no further mention at this point.

The skilled person is aware of suitable polyesters which can be used as polymeric resin (H), and of their preparation from DE 40 09 858 A1, for example.

As organic solvents which are present alongside water in any case in the mixture (vdM) the components are contemplated that are known in this context to the skilled person. Examples of such organic solvents include (hetero) cyclic, (hetero)aliphatic or (hetero)aromatic hydrocarbons, mono- or polyfunctional alcohols, ethers, esters, ketones, and amides, such as, for example, N-methylpyrrolidone, N-ethylpyrrolidone, dimethylformamide, toluene, xylene, butanol, ethyl glycol and butyl glycol and their acetates, butyl diglycol, diethylene glycol dimethyl ether, cyclohexanone, methyl ethyl ketone, methyl isobutyl ketone, acetone, isophorone or mixtures thereof.

The emulsifiers already mentioned above and present preferably in the mixture (vdM), which are referred to also below as emulsifiers (E), may be the components known in this context to the skilled person. The emulsifiers are preferably selected from the group consisting of lecithins and C₁₂-C₂₄ fatty alcohol polyglycol ethers. The polyglycol ethers used may in this case be etherified wholly or partially with C₁₂-C₂₄ fatty alcohols. An example of a suitable lecithin, i.e., of a suitable phospholipid, is Lipotin® A, which is available commercially. Also suitable is soyalecithin. Examples of suitable C₁₂-C₂₄ fatty alcohol polyglycol ethers are the commercially available products Lutensol® ON 60 and Lutensol® XP 70.

Specified below are preferred proportions and ratios of the components necessarily or preferably present in the mixture (vdM).

Where the mixture (vdM) is prepared using at least one emulsifier (E), the relative weight ratio of polymeric resins (H) to component (E) is preferably in the range from 50:1 to 1.5:1, more preferably in the range from 35:1 to 1.75:1, very preferably in the range from 30:1 to 1.5:1, especially preferably in the range from 10:1 to 2:1.

The at least one emulsifier (E) is preferably present in the mixture (vdM) in an amount of 0.1 to 10 wt %, more preferably 0.1 to 7.5 wt %, very preferably of 1.5 to 5 wt %, based in each case on the total weight of the mixture (vdM).

The relative weight ratio of the polymeric resins (H) and of the polyamides (P) in the mixture (vdM) to one another is preferably in a range of 20:1 to 1:1, more preferably in a range from 17.5 to 1.2:1, very preferably in a range from 15:1 to 2:1.

The polyamide (P) is present in the mixture (vdM) preferably in an amount in a range from 0.1 to 15 wt %, more preferably from 0.2 to 12.5 wt %, very preferably from 0.5 to 10 wt %, more preferably still from 0.75 to 9 wt %, most preferably from 1 to 8 wt % or from 1 to 7 wt %, based in each case on the total weight of the mixture.

The at least one polymeric resin (H) is preferably present in the mixture (vdM) in an amount in a range from 5.0 to 40 wt %, more preferably from 7.5 to 35.0 wt %, based in each case on the total weight of the mixture.

Determining or specifying the fraction of various components such as a polymeric resin or a polyamide in a mixture (vdM) or else in a basecoat material is done via the determination of the solids content (also called nonvolatile fraction or solids fraction) of the dispersion, solution or dilution of the component in question that is added to the mixture or to the basecoat material.

By solids content (nonvolatile fraction) is meant that weight fraction which remains as a residue on evaporation under specified conditions (for measurement method, see Examples section).

The fraction of organic solvents in the mixture (vdM) is for example from 5 to 60 wt %, preferably 10 to 55 wt %, based in each case on the total weight of the mixture.

The fraction of water in the mixture (vdM) may vary widely and is for example from 2 to 70 wt %, based in each case on the total weight of the mixture.

The components described above, namely the polyamide (P), the resins (H), the emulsifiers (E), and also water and organic solvents, preferably make up at least 90 wt %, more preferably at least 95 wt %, of the mixture (vdM).

The fraction of the mixture (vdM), based on the total amount of basecoat material (b.2.1), is preferably from 5 to 30 wt %, more preferably 7.5 to 25 wt %.

The procedure preferred here is for the at least one polyamide (P) to be present in the basecoat material in a fraction of 0.05 to 5 wt %, more preferably in an amount in a range from 0.1 to 4.0 wt %, very preferably in an amount in a range from 0.15 to 3.0 wt %, more preferably still in an amount in a range from 0.2 to 2.0 wt %, based in each case on the total weight of the basecoat material (b.2.1).

In the case of a possible particularization to basecoat materials comprising preferred mixtures (vdM) in a specific proportional range, the following applies. The mixtures (vdM) which do not fall within the preferred group may of course still be present in the basecoat material. In that case the specific proportional range applies only to the preferred group of mixtures (vdM). It is preferred nonetheless for the total proportion of mixtures, consisting of mixtures (vdM) from the preferred group and mixtures (vdM) which are not part of the preferred group, to be subject likewise to the specific proportional range.

In the case of a restriction to a proportional range of 5 to 35 wt % and to a preferred group of mixtures (vdM), therefore, this proportional range evidently applies initially only to the preferred group of mixtures (vdM). In that case, however, it would be preferable for there to be likewise from 5 to 35 wt % in total present of all originally encompassed mixtures (vdM). If, therefore, 25 wt % of mixtures (vdM) of the preferred group are used, not more than 10 wt % of the mixtures (vdM) of the non-preferred group may be used.

The stated principle is valid, for the purposes of the present invention, for all stated components of the basecoat material and for their proportional ranges—for example, for the pigments specified later on below, or else for the crosslinking agents specified later on below, such as melamine resins.

The basecoat material (b.2.1) for use in accordance with the invention preferably comprises at least one pigment. Reference here is to conventional pigments imparting color and/or optical effect.

Such color pigments and effect pigments are known to those skilled in the art and are described, for example, in Rompp-Lexikon Lacke and Druckfarben, Georg Thieme Verlag, Stuttgart, N.Y., 1998, pages 176 and 451. The terms “coloring pigment” and “color pigment” are interchangeable, just like the terms “optical effect pigment” and “effect pigment”.

Preferred effect pigments are, for example, plateletshaped metal effect pigments such as lamellar aluminum pigments, gold bronzes, oxidized bronzes and/or iron oxide-aluminum pigments, pearlescent pigments such as pearl essence, basic lead carbonate, bismuth oxide chloride and/or metal oxide-mica pigments and/or other effect pigments such as lamellar graphite, lamellar iron oxide, multilayer effect pigments composed of PVD films and/or liquid crystal polymer pigments. Particularly preferred are lamellar metal effect pigments, more particularly lamellar aluminum pigments.

Typical color pigments especially include inorganic coloring pigments such as white pigments such as titanium dioxide, zinc white, zinc sulfide or lithopone; black pigments such as carbon black, iron manganese black, or spinel black; chromatic pigments such as chromium oxide, chromium oxide hydrate green, cobalt green or ultramarine green, cobalt blue, ultramarine blue or manganese blue, ultramarine violet or cobalt violet and manganese violet, red iron oxide, cadmium sulfoselenide, molybdate red or ultramarine red; brown iron oxide, mixed brown, spinel phases and corundum phases or chromium orange; or yellow iron oxide, nickel titanium yellow, chromium titanium yellow, cadmium sulfide, cadmium zinc sulfide, chromium yellow or bismuth vanadate.

The fraction of the pigments is preferably situated in the range from 1.0 to 40.0 wt %, preferably 2.0 to 35.0 wt %, more preferably 5.0 to 30.0 wt %, based on the total weight of the aqueous basecoat material (b.2.1) in each case.

The aqueous basecoat material (b.2.1) comprises at least one polymer as binder, more particularly at least one polymer selected from the group consisting of polyurethanes, polyesters, poly(meth)acrylates and/or copolymers of the stated polymers, more particularly polyesters, poly(meth)acrylates and/or polyurethane poly(meth)acrylates. At least one polymer as binder is always present proportionally or completely through the addition of the mixture (vdM). Preferably, however, at least one further polymer is used as binder that is not added in the form of the mixture (vdM). The basecoat material (b.2.1) preferably comprises at least one polymer selected from the group consisting of polyurethanes, polyesters, poly(meth)acrylates and/or copolymers of the stated polymers and not present in the form of the mixture (vdM).

Preferred polyesters are described, for example, in DE 4009858 A1 in column 6, line 53 to column 7, line 61 and column 10, line 24 to column 13, line 3, or WO 2014/033135 A2, page 2, line 24 to page 7, line 10 and page 28, line 13 to page 29, line 13. Preferred polyurethane-poly(meth)acrylate copolymers ((meth)acrylated polyurethanes) and their preparation are described in, for example, WO 91/15528 A1, page 3, line 21 to page 20, line 33, and DE 4437535 A1, page 2, line 27 to page 6, line 22. The described polymers as binders are preferably hydroxy-functional and especially preferably possess an OH number in the range from 15 to 200 mg KOH/g, more preferably from 20 to 150 mg KOH/g. The basecoat materials more preferably comprise at least one hydroxy-functional polyurethanepolyacrylate copolymer, more preferably still at least one hydroxy-functional polyurethane-poly(meth)acrylate copolymer and also at least one hydroxy-functional polyester.

Likewise used with preference are poly(meth)acrylates, especially those preparable by multistage radical emulsion polymerization of olefinically unsaturated monomers in water. Particularly preferred are poly(meth)acrylate-based polymeric resins which are preparable by
i. polymerization of a mixture of olefinically unsaturated monomers A by emulsion polymerization in water using an emulsifier and a water-soluble initiator,
ii. polymerization of a mixture of olefinically unsaturated monomers B by emulsion polymerization in water using an emulsifier and a water-soluble initiator, in the presence of the polymer obtained under i., this mixture of olefinically unsaturated monomer B preferably comprising at least one polyolefinically unsaturated monomer,
iii. polymerization of a mixture of olefinically unsaturated monomers C by emulsion polymerization in water using an emulsifier and a water-soluble initiator, in the presence of the polymer obtained under ii.

The proportion of the polymers as binders which are not added in the form of the mixture (vdM) to the basecoat material may vary widely and is situated preferably in the range from 1.0 to 25.0 wt %, more preferably 3.0 to 20.0 wt %, very preferably 5.0 to 15.0 wt %, based in each case on the total weight of the basecoat material (b.2.1).

The basecoat material (b.2.1) may further comprise at least one typical crosslinking agent known per se. If it comprises a crosslinking agent, said agent comprises preferably at least one aminoplast resin and/or at least one blocked polyisocyanate, preferably an aminoplast resin. Among the aminoplast resins, melamine resins in particular are preferred.

If the basecoat material (b.2.1) does comprise crosslinking agents, the proportion of these crosslinking agents, more particularly aminoplast resins and/or blocked polyisocyanates, very preferably aminoplast resins and, of these, preferably melamine resins, is preferably in the range from 0.5 to 20.0 wt %, more preferably 1.0 to 15.0 wt %, very preferably 1.5 to 10.0 wt %, based in each case on the total weight of the basecoat material (b.2.1).

Furthermore, the basecoat material (b.2.1) may further comprise at least one further adjuvant (additive). Examples of such adjuvants are salts which are thermally decomposable without residue or substantially without residue, polymers as binders that are curable physically, thermally and/or with actinic radiation and that are different from the polymers already stated, further crosslinking agents, organic solvents, reactive diluents, transparent pigments, fillers, molecularly dispersely soluble dyes, nanoparticles, light stabilizers, antioxidants, deaerating agents, emulsifiers, slip additives, polymerization inhibitors, initiators of radical polymerizations, adhesion promoters, flow control agents, film-forming assistants, sag control agents (SCAs), flame retardants, corrosion inhibitors, waxes, siccatives, biocides, and matting agents. Such adjuvants are used in the customary and known amounts.

The solids content of the basecoat material (b.2.1) may vary according to the requirements of the case in hand. The solids content is guided primarily by the viscosity that is needed for application, more particularly spray application. A particular advantage is that the basecoat material for inventive use, for comparatively high solids contents, is able nevertheless to have a viscosity which allows appropriate application.

The solids content of the basecoat material is preferably at least 16.5%, more preferably at least 18.0%, even more preferably at least 20.0%.

Under the stated conditions, in other words at the stated solids contents, preferred basecoat materials (b.2.1) have a viscosity of 40 to 150 mPa·s, more particularly 70 to 120 mPa·s, at 23° C. under a shearing load of 1000 l/s (for further details regarding the measurement method, see Examples section). For the purposes of the present invention, a viscosity within this range under the stated shearing load is referred to as spray viscosity (working viscosity). As is known, coating materials are applied at spray viscosity, meaning that under the conditions then present (high shearing load) they possess a viscosity which in particular is not too high, so as to permit effective application. This means that the setting of the spray viscosity is important, in order to allow a paint to be applied at all by spray methods, and to ensure that a complete, uniform coating film is able to form on the substrate to be coated.

The basecoat material (b.2.1) for inventive use is aqueous, meaning a system that comprises primarily water as solvent and that comprises organic solvents only in minor fractions.

The fraction of water in the basecoat material (b.2.1) is preferably from 35 to 75 wt %, and more preferably 45 to 70 wt %, based in each case on the total weight of the basecoat material.

Even more preferred is for the percentage sum of the solids content of the basecoat material and the fraction of water in the basecoat material to be at least 70 wt %, preferably at least 75 wt %. Among these figures, preference is given to ranges of 75 to 95 wt %, in particular 80 to 90 wt %.

This means in particular that preferred basecoat materials comprise components that are in principle a burden on the environment, such as organic solvents in particular, in relation to the solids content of the basecoat material, at only low fractions. The ratio of the volatile organic fraction of the basecoat material (in wt %) to the solids content of the basecoat material (in analogy to the representation above, here in wt %) is preferably from 0.1 to 1.5, more preferably from 0.2 to 1.0. In the context of the present invention, the volatile organic fraction is considered to be that fraction of the basecoat material that is considered neither part of the water fraction nor part of the solids content.

Another advantage of the basecoat material (b.2.1) is that it can be prepared without the use of ecounfriendly and health-injurious organic solvents such as N-methyl-2-pyrrolidone, dimethylformamide, dioxane, tetrahydrofuran, and N-ethyl-2-pyrrolidone. Accordingly, the basecoat material preferably contains less than 10 wt %, more preferably less than 5 wt %, more preferably still less than 2.5 wt % of organic solvents selected from the group consisting of N-methyl-2-pyrrolidone, dimethylformamide, dioxane, tetrahydrofuran, and N-ethyl-2-pyrrolidone. The basecoat material is preferably entirely free from these organic solvents.

The basecoat materials can be produced using the mixing assemblies and mixing techniques that are customary and known for the production of basecoat materials.

For the basecoat materials (b.2.2.x) used in the method of the invention it is the case that at least one of these basecoat materials has the inventively essential features described for the basecoat material (b.2.1). This means, in particular, that at least one of the basecoat materials (b.2.2.x) comprises at least one mixture (vdM). The preferred features and embodiments described as part of the description of the basecoat material (b.2.1) preferably also apply to at least one of the basecoat materials (b.2.2.x). The above preferably applies to all of the basecoat materials (b.2.2.x) used.

In the preferred variants of stage (2.2) of the method of the invention, described earlier on above, a first basecoat material (b.2.2.a) is first of all applied, and may also be termed a color-preparatory basecoat material. It therefore serves as a base for at least one color and/or effect basecoat film that then follows, this being a film which is then able optimally to fulfill its function of imparting color and/or effect.

In one particular embodiment, a color-preparatory basecoat material is substantially free from chromatic pigments and effect pigments. More particularly preferably a basecoat material of this kind contains less than 2 wt %, preferably less than 1 wt %, of chromatic pigments and effect pigments, based in each case on the total weight of the aqueous basecoat material. In this embodiment the color-preparatory basecoat material preferably comprises black and/or white pigments, especially preferably both kinds of these pigments. It comprises preferably 5 to 30 wt %, preferably 10 to 25 wt %, of white pigments, and 0.01 to 1.00 wt %, preferably 0.1 to 0.5 wt %, of black pigments, based in each case on the total weight of the basecoat material. The resultant white, black, and more particularly gray color, which can be adjusted in different lightness stages through the ratio of white pigments and black pigments, represents an individually adaptable basis for the basecoat film system that then follows, allowing the color and/or the effect imparted by the subsequent basecoat system to be manifested optimally. The pigments are known to the skilled person and have also been described earlier on above. A preferred white pigment here is titanium dioxide, a preferred black pigment carbon black. As already described, however, this basecoat material may of course also comprise chromatic and/or effect pigments. This variant is appropriate especially when the resultant multicoat paint system is to have a highly chromatic hue, as for example a very deep red or yellow. Where pigments in appropriately chromatic hue are also added to the color-preparatory basecoat material, a further improved coloration can be achieved.

The color and/or effect basecoat material(s) for the second basecoat film or for the second and third basecoat films within this embodiment are adapted in accordance with the ultimately desired coloration of the overall system. Where the desire is for a white, black, or gray color, the at least one further basecoat material comprises the corresponding pigments and in terms of the pigment composition ultimately resembles the color-preparatory basecoat material. Where the desire is for a chromatic and/or effect paint system, as for example a chromatic solid-color paint system or a metallic-effect paint system, corresponding chromatic and/or effect pigments are used in amounts of, for example, 1 to 15 wt %, preferably 3 to 10 wt %, based in each case on the total weight of the basecoat material. Chromatic pigments belong to the group of color pigments, the latter also encompassing achromatic color pigments such as black or white pigments. Basecoat materials of this kind may of course also include black and/or white pigments as well for the purpose of lightness adaptation.

The method of the invention allows multicoat paint systems to be produced on metallic substrates without a separate curing step. Nevertheless, application of the method of the invention results in multicoat paint systems which exhibit optical and/or esthetic properties, meaning that even relatively high film thicknesses of the corresponding basecoat films can be built up without loss of esthetic quality.

### EXAMPLES

### Solids Content (Nonvolatile Fraction)

The nonvolatile fraction is determined according to DIN EN ISO 3251 (date: June 2008). It involves weighing out 1 g of sample into an aluminum dish which has been dried beforehand, drying it in a drying oven at 125° C. for 60 minutes, cooling it in a desiccator and then reweighing it. The residue relative to the total amount of sample used corresponds to the nonvolatile fraction. The volume of the nonvolatile fraction may optionally be determined if necessary according to DIN 53219 (date: August 2009).

Film Thicknesses

The film thicknesses are determined according to DIN EN ISO 2808 (date: May 2007), method 12A, using the MiniTest® 3100-4100 instrument from ElektroPhysik.

Acid Number

The acid number is determined in accordance with DIN EN ISO 2114 (date: June 2002), proceeding fundamentally according to “method A”. The acid number corresponds to the mass of potassium hydride in mg that is needed to neutralize 1 g of sample under the conditions specified in DIN EN ISO 2114. The acid number of a carboxy-functional component in an otherwise carboxyl-free sample, as for example of a polyamide in a dilution of the polyamide obtainable as a commercial product, can be obtained by corresponding conversion (taking account of the solids content, in other words the actual active substance of the sample or the amount of polyamide in the dilution). It is also possible for the component, such as the polyamide, to be isolated beforehand and then for the acid number to be determined on the polyamide itself, in other words, ultimately, on the solids portion of the dilution available for example as a commercial product.

The indication selected above that the procedure adopted was in principle (in other words, in general) that according to “method A” from the stated standard, should be understood as follows: where a sample or a component isolated beforehand does not dissolve fully in the solvent mixture indicated in the standard, an alternative solvent mixture was used in order to dissolve the sample or component completely. Where appropriate, operation also took place at slightly elevated temperatures, 30° C. for example, in order to ensure complete dissolution prior to titration. Typically for example, complete dissolution of various commercial polyamide products such as Disparlon AQ600, can be achieved in 2:1 v/v xylene:propanol.

Although it is of course possible in principle to determine the acid number with the solvent mixture specified in the standard, in which case possibly not all of the carboxy functions present are detected, a reproducible and representative result is nevertheless obtained by always measuring a completely dissolved sample or component in the context of the present invention.

OH Number

The OH number is determined in accordance with DIN 53240-2 (date: November 2007). The OH groups are reacted by acetylation with an excess of acetic anhydride. The excess acetic anhydride is then split by addition of water to form the acetic acid, and the entire acetic acid is back-titrated with ethanolic KOH. The OH number indicates the amount of KOH in mg which is equivalent to the amount of acetic acid bound in the acetylation of 1 g of sample.

Determination of the Number-Average and Weight-Average Molecular Weights

The number-average molecular weight (Mₙ) is determined by gel permeation chromatography (GPC). This method of determination is based on DIN 55672-1 (date: August 2007). As well as the number-average molecular weight, the weight-average molecular weight (M_{w}) and also the polydispersity (ratio of weight-average molecular weight (M_{w}) to number-average molecular weight (Mₙ)) can also be determined by this method. The eluent used is tetrahydrofuran. The determination takes place against polystyrene standards. The column material consists of styrene-divinylbenzene copolymers.

Determination of the Storage Stability

For determining the storage stability of basecoat materials, they are investigated before and after storage at 40° C. for 2 weeks with a rotational viscometer that is in accordance with DIN 53019-1 (date: September 2008) and is calibrated according to DIN 53019-2 (date: February 2001), under temperature-controlled conditions (23.0° C.±2.0° C.). In this analysis, the samples are first sheared for 5 minutes at a rate of 1000 s⁻¹ (loading phase) and then for 8 minutes at a rate of 1 s⁻¹ (unloading phase). The average viscosity level during the loading phase (high-shear viscosity) and also the level after 8 minutes of unloading phase (low-shear viscosity) are determined from the measurement data, and the values before and after storage are compared with one another, by calculating the respective percentage changes.

Painting of Waterborne Basecoat Material Wedge Constructions

To assess the incidence of pinholes and also the flow as a function of film thickness, wedge-format multicoat paint systems are produced in accordance with the following general protocols:

Variant A: First Waterborne Basecoat Material as Wedge, Second Waterborne Basecoat Material as Constant Coat

A steel panel with dimensions of 30×50 cm, coated with a cured standard CEC (CathoGuard® 800 from BASF Coatings), is provided with two adhesive strips (Tesaband adhesive tape, 19 mm) at one longitudinal edge, to allow determination of film thickness differences after coating.

The first waterborne basecoat material is applied electrostatically as a wedge with a target film thickness (film thickness of the dried material) of 0-30 μm. After flashing at room temperature for 3 minutes, one of the two adhesive strips is removed and then the second waterborne basecoat material is applied likewise electrostatically in a single application. The target film thickness (film thickness of the dried material) is 13-16 μm. After a further flashing time of 4 minutes at room temperature, the system is interim-dried in a forced air oven at 60° C. for 10 minutes. Following removal of the second adhesive strip, a commercial two-component clearcoat material (ProGloss® from BASF Coatings GmbH) is applied by gravity-fed spray gun manually to the interim-dried system, with a target film thickness (film thickness of the dried material) of 40-45 μm. The resulting clearcoat film is flashed at room temperature (18 to 23° C.) for 10 minutes; subsequently, curing takes place in a forced air oven at 140° C. for a further 20 minutes.

Variant B: First Waterborne Basecoat Material as Constant Coat, Second Waterborne Basecoat Material as Wedge

A steel panel with dimensions of 30×50 cm, coated with a cured standard CEC (CathoGuard® 800 from BASF Coatings), is provided with two adhesive strips (Tesaband adhesive tape, 19 mm) at one longitudinal edge, to allow determination of film thickness differences after coating.

The first waterborne basecoat material is applied electrostatically with a target film thickness (film thickness of the dried material) of 18-22 μm. After flashing at room temperature for 3 minutes, one of the two adhesive strips is removed and then the second waterborne basecoat material is applied likewise electrostatically in a single application as a wedge. The target film thickness (film thickness of the dried material) is 0-30 μm. After a further flashing time of 4 minutes at room temperature, the system is interim-dried in a forced air oven at 60° C. for 10 minutes. Following removal of the second adhesive strip, a commercial two-component clearcoat material (ProGloss® from BASF Coatings GmbH) is applied by gravity-fed spray gun manually to the interim-dried system, with a target film thickness (film thickness of the dried material) of 40-45 μm. The resulting clearcoat film is flashed at room temperature (18 to 23° C.) for 10 minutes; subsequently, curing takes place in a forced air oven at 140° C. for a further 20 minutes.

Assessment of the Incidence of Pinholes

To assess the incidence of pinholes, multicoat paint systems are produced as per the methods for the painting of waterborne basecoat material wedge systems (variant A and B, respectively), and are then evaluated visually according to the following general protocol:

The dry film thickness of the overall waterborne basecoat material system, consisting of the first and second waterborne basecoat materials, is checked and, for the basecoat film thickness wedge, the 0-20 μm region and the region from 20 μm to the end of the wedge are marked on the steel panel.

The pinholes are evaluated visually in the two separate regions of the waterborne basecoat material wedge. The number of pinholes per region is counted. All results are standardized to an area of 200 cm². In addition, optionally, a record is made of that dry film thickness of the waterborne basecoat material wedge from which pinholes no longer occur.

Assessment of the Film Thickness-Dependent Leveling

To assess the film thickness-dependent leveling, multicoat paint systems are produced as per the methods for the painting of waterborne basecoat material wedge systems (variant A or B, respectively), and are then evaluated according to the following general protocol:

The dry film thickness of the overall waterborne basecoat material system, consisting of the waterborne basecoat material or of the first and second waterborne basecoat materials, is checked and, for the basecoat film thickness wedge, the 15-20 μm and also 20-25 μm regions, or 10-15 μm, 15-20 μm, 20-25 μm, 25-30 μm, and, optionally, 30-35 μm regions are marked on the steel panel.

The determination or assessment of the film thickness-dependent leveling takes place by means of the Wave scan instrument from Byk/Gardner within the four basecoat film thickness regions determined beforehand. For this purpose, a laser beam is directed at an angle of 60° onto the surface under investigation, and the fluctuations in the reflected light in the so-called short wave range (0.3 to 1.2 mm) and in the so-called long wave range (1.2 to 12 mm) are recorded by the instrument over a measuring distance of 10 cm (long wave=LW; short wave=SW; the lower the values, the better the appearance). Moreover, as a measure of the sharpness of an image reflected in the surface of the multicoat system, the instrument determines the characteristic variable “distinctness of image” (DOI) (the higher the value, the better the appearance).

Assessment of the Incidence of Gel Specks

To assess the incidence of gel specks, the basecoat materials are investigated according to the following general protocols:

a) Coating of a Glass Panel

The waterborne basecoat material in question is applied using a 150 μm four-way bar applicator to a glass panel with dimensions 9×15 cm. In the wet state and also after a 60-minute flashoff time at room temperature, the film is inspected for gel specks, by holding it against a light source, so that any air inclusions are not misinterpreted as gel specks. A rating of 1-5 is awarded (1=no specks/5=very many specks), or a judgment is made relative to a reference (reference=0; ++=much better; +=better; −=poorer; −−=much poorer).

b) Coating of a Steel Panel

The waterborne basecoat material is applied by dual application to a steel panel with dimensions of 32×60 cm, coated with a cured standard CEC (CathoGuard® 800 from BASF Coatings); application in a first step is electrostatic, with a target film thickness of 8-9 μm, and in the second step, after a 2-minute flashoff time at room temperature, application is pneumatic, with a target film thickness of 4-5 μm. Subsequently, after a further flashoff time at room temperature of 5 minutes, the resulting waterborne basecoat film is dried in a forced air oven at 80° C. for 5 minutes. Applied to the dried waterborne basecoat film is a commercial two-component clearcoat material (ProGloss from BASF Coatings GmbH), with a target film thickness of 40-45 μm. The resulting clearcoat film is flashed off at room temperature for 10 minutes; it is then cured in a forced air oven at 140° C. for a further 20 minutes. Specks are evaluated visually; a rating of 1-5 is awarded (1=no specks/5=very many specks).

Visual Evaluation of Separation

The basecoat materials are evaluated visually for stability, by storing them in each case in a closed glass vessel at room temperature and/or at 40° C. over a period of at least four weeks. This is followed by inspection to determine whether separation has taken place or whether the material has changed in its homogeneity. A rating of 1-5 is awarded (1=very stable; no separation and/or no formation of multiple phases/5=very unstable; severe separation or very distinct formation of multiple phases).

1. Preparation of Mixtures Comprising Polyamides and Preparation of Aqueous Basecoat Materials

The following should be taken into account regarding the formulation constituents and amounts thereof that are indicated in the tables which follow. When reference is made to a commercial product or to a preparation protocol described elsewhere, the reference, independently of the principal designation selected for the constituent in question, is to precisely this commercial product or precisely the product prepared with the referenced protocol.

Accordingly, where a formulation constituent possesses the principal designation “melamine-formaldehyde resin” and where a commercial product is indicated for this constituent, the melamine-formaldehyde resin is used in the form of precisely this commercial product. Any further constituents present in the commercial product, such as solvents, must therefore be taken into account if conclusions are to be drawn about the amount of the active substance (of the melamine-formaldehyde resin).

If, therefore, reference is made to a preparation protocol for a formulation constituent, and if such preparation results, for example, in a polymer dispersion having a defined solids content, then precisely this dispersion is used. The overriding factor is not whether the principal designation that has been selected is the term “polymer dispersion” or merely the active substance, for example, “polymer”, “polyester”, or “polyurethane-modified polyacrylate”. This must be taken into account if conclusions are to be drawn concerning the amount of the active substance (of the polymer).

All proportions indicated in the tables are parts by weight.

1.1 Preparation of Predispersed Mixtures (vdM) and Other Mixtures Comprising Polyamides

The components listed in tables 1.1 and 1.2 are stirred together in the order stated, with stirring at a temperature of 15-25° C., to give mixtures (vdM) 1 to 6 for inventive use. This mixture is then homogenized with stirring for a further 10 minutes. Stirring was carried out using the “Dispermat® LC30” device from VWA-Getzmann, Germany at a peripheral speed of the stirring disk used of 15 to 20 m/s.

TABLE 1.1
Preparation of mixtures (vdM) 1 to 4

| | (vdM) | (vdM) | (vdM) | (vdM) |
|---|---|---|---|---|
| | 1 | 2 | 3 | 4 |
| Melamine-formaldehyde resin | 23.9 | 26.7 | | |
| (Cymel ® 303 from Allnex) | | | | |
| Melamine-formaldehyde resin | | | 26.7 | |
| (Resimene ® 755 from Ineos) | | | | |
| Melamine-formaldehyde resin | | | | 23.5 |
| (Resimene ® HM 2608 from Ineos) | | | | |
| Dimethylethanolamine | 0.8 | 0.5 | 0.5 | 0.4 |
| Disparlon ® A670-20M, available | 13.7 | 16.2 | 16.2 | 14.3 |
| from Kusomoto Chemicals, Ltd. | | | | |
| Butyl glycol | 32.9 | 32.5 | 32.5 | 28.7 |
| 2,4,7,9-tetramethyl-5-decynediol, | 3.6 | 4.9 | 4.9 | 4.3 |
| 52% in BG (available from BASF SE) | | | | |
| Polyester; prepared as for | 25.1 | 19.2 | 19.2 | 28.7 |
| example D, column 16, lines | | | | |
| 37-59 of DE 40 09 858 A1 | | | | |

TABLE 1.2
Preparation of mixtures (vdM) 5 and (vdM) 6

| | (vdM) | (vdM) |
|---|---|---|
| | 5 | 6 |
| Polyester; prepared as for | 22.50 | 22.50 |
| example D, column 16, lines | | |
| 37-59 of DE 40 09 858 A1 | | |
| Dimethylethanolamino | 0.45 | 0.45 |
| 2,4,7,9-tetramethyl-5-decynediol, | 3.00 | 3.00 |
| 52% in BG (available from BASF SE) | | |
| LIPOTIN ® A, available from Evonik | 3.00 | 3.00 |
| Industries AG | | |
| Deionized water | 56.05 | 56.05 |
| Disparlon ® 6900-20X, available from | 15.00 | |
| Kusomoto Chemicals, Ltd. | | |
| Disparlon ® A670-20M, available from | | 15.00 |
| Kusomoto Chemicals, Ltd. | | |

The components listed in table 1.3 are stirred together in the order stated with stirring to give the polyamide-containing mixtures PM 1 and 2, to be used for comparison. This mixture is subsequently stirred intensely for 10 minutes.

TABLE 1.3
Preparation of the polyamide-containing mixtures PM 1 and 2

| | PM 1 | PM 2 |
|---|---|---|
| Disparlon ® AQ630, available from | 20 | |
| Kusomoto Chemicals, Ltd. | | |
| Disparlon ® AQ600, available from | | 50 |
| Kusomoto Chemicals, Ltd. | | |
| Isobutanol | | 18.5 |
| Deionized water | 78.5 | 31.5 |
| 2,4,7,9-Tetramethyl-5-decynediol, | 1 | |
| 52% in BG (available from BASF SE) | | |
| Agitan ® 282 from Münzing Chemie | 0.5 | |
| GmbH | | |

The polyamide in the commercial product Disparlon® AQ600 from Kusumoto Chemicals, Ltd (nonvolatile fraction of the commercial product: 20 wt %) possesses an acid number of 66 mg KOH/g. The polyamide in the commercial product Disparlon® AQ630 from Kusumoto Chemicals, Ltd (nonvolatile fraction of the commercial product: 18 wt %) possesses an acid number of 75 mg KOH/g. The polyamide in the commercial product Disparlon® A670-20M from Kusumoto Chemicals, Ltd (nonvolatile fraction of the commercial product: 20 wt %) possesses an acid number of 9 mg KOH/g. The polyamide in the commercial product Disparlon® 6900-20X from Kusumoto Chemicals, Ltd (nonvolatile fraction of the commercial product: 20 wt %) possesses an acid number of 0.9 mg KOH/g.

1.2 Preparation of Aqueous Basecoat Materials

1.2A Preparation of aqueous basecoat materials WBM A1 (comparative) and WBM A2 (comparative)

The components listed under “Aqueous phase” in table A are combined with stirring in the order stated to form an aqueous mixture. This mixture is then stirred for 10 minutes and adjusted using deionized water and dimethylethanolamine to a pH of 8 and to a spray viscosity of 90 mPa·s under a shearing load of 1291 s⁻¹, as measured using a rotary viscometer (Rheolab QC instrument with C-LTD80/QC heating system from Anton Paar) at 23° C.

TABLE A
Preparation of waterborne basecoat
materials WBM A1 and WBM A2

| | |
|---|---|
| WBM A1 | WBM A2 |

Aqueous phase:

| | | |
|---|---|---|
| 3% strength Na Mg phyllosilicate | 15.23 | 15.23 |
| solution | | |
| Deionized water | 5.68 | |
| 1-Propoxy-2-propanol | 1.41 | 1.41 |
| 2-Ethylhexanol | 0.87 | 0.87 |
| Polyurethane-based graft copolymer; | 26.51 | |
| prepared as per page 35, line 33 to | | |
| page 36, line 22 (example D-B2) of | | |
| WO 2015/007427 A1 | | |
| Aqueous dispersion of a | | 31.23 |
| poly(meth)acrylate emulsion | | |
| polymer having a nonvolatile | | |
| fraction of 26-28% | | |
| Polyester; prepared as per | 3.66 | |
| page 28, lines 13 to 33 (example | | |
| BE1) of WO 2014/033135 A2 | | |
| Polyester; prepared as per | | 4.85 |
| example D, column 16, lines | | |
| 37-59 of DE 40 09 858 A1 | | |
| Melamine-formaldehyde resin | 5.44 | 5.44 |
| (Cymel ® 203 from Allnex) | | |
| 10% strength dimethylethanolamine in | 0.55 | 0.30 |
| water | | |
| 2,4,7,9-Tetramethyl-5-decynediol, | 1.09 | 1.09 |
| 52% in BG (available from BASF SE) | | |
| Triisobutyl phosphate | 1.63 | 1.63 |
| Polyurethane-modified polyacrylate; | 2.91 | 2.91 |
| prepared as per page 7, line 55 to | | |
| page 8, line 23 of DE 4437535 A1 | | |
| Butyl glycol | 4.35 | 4.35 |
| Isopar ® L, available from Exxon Mobil | 1.84 | 1.84 |
| Pluriol ® P900, available from BASF SE | 0.54 | 0.54 |
| Hydrosol A170, available from DHC | 0.54 | 0.54 |
| Solvent Chemie GmbH | | |
| White paste | 25.68 | 25.68 |
| Black paste | 1.53 | 1.52 |
| Yellow paste | 0.54 | 0.54 |

Preparation of the White Paste

The white paste is prepared from 50 parts by weight of titanium rutile 2310, 6 parts by weight of a polyester prepared as for example D, column 16, lines 37-59 of DE 40 09 858 A1, 24.7 parts by weight of a binder dispersion prepared as per patent application EP 022 8003 B2, page 8, lines 6 to 18, 10.5 parts by weight of deionized water, 4 parts by weight of 2,4,7,9-tetramethyl-5-decynediol, 52% in BG (available from BASF SE), 4.1 parts by weight of butyl glycol, 0.4 part by weight of 10% strength dimethylethanolamine in water, and 0.3 part by weight of Acrysol RM-8 (available from The Dow Chemical Company).

Preparation of the Black Paste

The black paste is prepared from 57 parts by weight of a polyurethane dispersion prepared as per WO 92/15405, page 13, line 13 to page 15, line 13, 10 parts by weight of carbon black (Monarch® 1400 carbon black from Cabot Corporation), 5 parts by weight of a polyester prepared as per example D, column 16, lines 37-59 of DE 40 09 858 A1, 6.5 parts by weight of a 10% strength aqueous dimethylethanolamine solution, 2.5 parts by weight of a commercial polyether (Pluriol® P900, available from BASF SE), 7 parts by weight of butyl diglycol, and 12 parts by weight of deionized water.

Preparation of the Yellow Paste

The yellow paste is prepared from 37 parts by weight of Bayferrox 3910 (available from Lanxess), 49.5 parts by weight of an aqueous binder dispersion prepared as per WO 91/15528, page 23, line 26 to page 25, line 24, 7.5 parts by weight of Disperbyk®-184 (available from BYK-Chemie GmbH), and 6 parts by weight of deionized water.

1.2B Preparation of Aqueous Basecoat Materials WBM B1 (Comparative), WBM B2 (Inventive) and WBM B3-6 (Comparative)

The components listed under “Aqueous phase” in table B are combined with stirring in the order stated to form an aqueous mixture. This mixture is then stirred for 10 minutes and adjusted using deionized water and dimethylethanolamine to a pH of 8 and to a spray viscosity of 110±10 mPa·s under a shearing load of 1000 s⁻¹, as measured using a rotary viscometer (Rheolab QC instrument with C-LTD80/QC heating system from Anton Paar) at 23° C.

TABLE B
Preparation of waterborne basecoat materials WBM B1 to WBM B6

| | | | | | |
|---|---|---|---|---|---|
| WBM | WBM | WBM | WBM | WBM | WBM |
| B1 | B2 | B3 | B4 | B5 | B6 |

Aqueous phase:

| | | | | | | |
|---|---|---|---|---|---|---|
| 3% Na—Mg phyllosilicate | 13.54 | | | | | |
| solution | | | | | | |
| (vdM) 1 | | 17.52 | | | | |
| PM 1 | | | 12.06 | | 18.09 | |
| PM 2 | | | | 3.95 | | 5.60 |
| Deionized water | 8.03 | 18.81 | | | | |
| 2-Ethylhexanol | 1.54 | 1.54 | 1.54 | 1.54 | 1.54 | 1.54 |
| Aqueous dispersion of | 44.04 | 44.04 | 44.04 | 44.04 | 44.04 | 44.04 |
| poly(meth)acrylate emulsion | | | | | | |
| polymer having a nonvolatile | | | | | | |
| fraction of 26-28% | | | | | | |
| Polyester; prepared as per | 4.40 | | 4.40 | 4.40 | 4.40 | 4.40 |
| example D, column 16, | | | | | | |
| line 37-59 of DE 40 09 858 A1 | | | | | | |
| Melamine-formaldehyde resin | 3.96 | | 3.96 | 3.96 | 3.96 | 3.96 |
| (Cymel ® 303 from Allnex) | | | | | | |
| 10% dimethylethanolamine in | 1.21 | | 1.21 | 1.21 | 1.21 | 1.21 |
| water | | | | | | |
| 2,4,7,9-Tetramethyl-5-decynediol, | 0.63 | 0.63 | 0.63 | 0.63 | 0.63 | 0.63 |
| 52% in BG (available from BASF SE) | | | | | | |
| Pluriol ® P900, available from BASF SE | 1.26 | 1.26 | 1.26 | 1.26 | 1.26 | 1.26 |
| Triisobutyl phosphate | 0.55 | 0.55 | 0.55 | 0.55 | 0.55 | 0.55 |
| NACURE 2500, available from | 0.72 | 0.72 | 0.72 | 0.72 | 0.72 | 0.72 |
| King Industries, Inc | | | | | | |
| Butyl glycol | 5.18 | | 5.18 | 5.18 | 5.18 | 5.18 |
| 50 wt % solution of Rheovis ® PU1250 | 0.63 | 0.63 | 0.63 | 0.63 | 0.63 | 0.63 |
| in butyl glycol (Rheovis ® PU1250 | | | | | | |
| available from BASF SE) | | | | | | |
| Black paste | 14.31 | 14.31 | 14.31 | 14.31 | 14.31 | 14.31 |
| Fraction of polyamide | 0.00% | 0.48% | 0.48% | 0.48% | 0.67% | 0.67% |
| in basecoat: | | | | | | |

Preparation of Black Paste

The black paste is prepared from 57 parts by weight of a polyurethane dispersion prepared as per WO 92/15405, page 13, line 13 to page 15, line 13, 10 parts by weight of carbon black (Monarch® 1400 carbon black from Cabot Corporation), 5 parts by weight of a polyester prepared as per example D, column 16, lines 37-59 of DE 40 09 858 A1, 6.5 parts by weight of a 10% strength aqueous dimethylethanolamine solution, 2.5 parts by weight of a commercial polyether (Pluriol® P900, available from BASF SE), 7 parts by weight of butyl diglycol, and 12 parts by weight of deionized water.

1.2C Preparation of Aqueous Basecoat Materials WBM B7 and B9 (Comparative) and Also WBM B8 and WBM 10 (Inventive)

The components listed under “Aqueous phase” in table C are combined with stirring in the order stated to form an aqueous mixture. This mixture is then stirred for 10 minutes and adjusted using deionized water and dimethylethanolamine to a pH of 8 and to a spray viscosity of 60±5 mPa·s (WBM B7, WBM B9) or 80±5 mPa·s (WBM B8, WBM B10) under a shearing load of 1000 s⁻¹, as measured using a rotary viscometer (Rheolab QC instrument with C-LTD80/QC heating system from Anton Paar) at 23° C.

TABLE C
Preparation of waterborne basecoat materials WBM B7 to WBM B10

| | | | |
|---|---|---|---|
| WBM B7 | WBM B8 | WBM B9 | WBM B10 |

Aqueous phase:

| | | | | |
|---|---|---|---|---|
| 3% Na—Mg phyllosilicate | 12.29 | | 12.29 | |
| solution | | | | |
| (vdM) 2 | | 14.45 | | |
| (vdM) 3 | | | | 14.44 |
| Deionized water | 8.74 | 13.50 | 8.73 | 13.50 |
| n-propanol | 0.82 | 0.82 | 0.82 | 0.82 |
| n-butoxypropanol | 1.29 | 1.29 | 1.29 | 1.29 |
| 2-ethylhexanol | 2.60 | 2.60 | 2.60 | 2.60 |
| Aqueous dispersion of | 42.73 | 42.73 | 42.74 | 42.74 |
| poly(meth)acrylate emulsion | | | | |
| polymer having a nonvolatile | | | | |
| fraction of 26-28% | | | | |
| Polyester; prepared as per | 2.77 | | 2.77 | |
| example D, column 16, line | | | | |
| 37-59 of DE 40 09 858 A1 | | | | |
| Melamine-formaldehyde resin | 3.86 | | | |
| (Cymel ® 303 from Allnex) | | | | |
| Melamine-formaldehyde resin | | | 3.86 | |
| (Resimene ® 755 from Ineos) | | | | |
| 10% dimethylethanolamine in water | 0.28 | | 0.28 | |
| 2,4,7,9-Tetramethyl-5-decynediol, | 1.30 | 1.30 | 1.30 | 1.30 |
| 52% in BG (available from BASF SE) | | | | |
| BYK-346, available from | 0.43 | 0.43 | 0.43 | 0.43 |
| Altana/BYK-Chemie GmbH | | | | |
| Isopropanol | 1.54 | 1.54 | 1.54 | 1.54 |
| Butyl glycol | 0.94 | 0.94 | 0.94 | 0.94 |
| Isopar ® L, available from | 0.82 | 0.82 | 0.82 | 0.82 |
| Exxon Mobil | | | | |
| NACURE 2500, available from | 0.40 | 0.40 | 0.40 | 0.39 |
| King Industries, Inc | | | | |
| Black paste | 13.13 | 13.13 | 13.13 | 13.13 |
| Barium sulfate paste | 3.00 | 3.00 | 3.00 | 3.00 |
| Steatite paste | 3.05 | 3.05 | 3.05 | 3.05 |

Preparation of Black Paste

The black paste is prepared from 57 parts by weight of a polyurethane dispersion prepared as per WO 92/15405, page 13, line 13 to page 15, line 13, 10 parts by weight of carbon black (Monarch® 1400 carbon black from Cabot Corporation), 5 parts by weight of a polyester prepared as per example D, column 16, lines 37-59 of DE 40 09 858 A1, 6.5 parts by weight of a 10% strength aqueous dimethylethanolamine solution, 2.5 parts by weight of a commercial polyether (Pluriol® P900, available from BASF SE), 7 parts by weight of butyl diglycol, and 12 parts by weight of deionized water.

Preparation of Barium Sulfate Paste

The barium sulfate paste is prepared from 39 parts by weight of a polyurethane dispersion prepared as per EP 0228003 B2, page 8, lines 6 to 18, 54 parts by weight of barium sulfate (Blanc fixe micro from Sachtleben Chemie GmbH), 3.7 parts by weight of butyl glycol, and 0.3 part by weight of Agitan 282 (available from Münzing Chemie GmbH), and 3 parts by weight of deionized water.

Preparation of Steatite Paste

The steatite paste is prepared from 49.7 parts by weight of an aqueous binder dispersion prepared as per WO 91/15528, page 23, line 26 to page 25, line 24, 28.9 parts by weight of steatite (Microtalc IT extra from Mondo Minerals B.V.), 0.4 part by weight of Agitan 282 (available from Münzing Chemie GmbH), 1.45 parts by weight of Disperbyk®-184 (available from BYK-Chemie GmbH), 3.1 parts by weight of a commercial polyether (Pluriol® P900, available from BASF SE) and 16.45 parts by weight of deionized water.

1.2D Preparation of Aqueous Basecoat Materials WBM B11 (Comparative) and WBM B12(Inventive)

The components listed under “Aqueous phase” in table D are combined with stirring in the order stated to form an aqueous mixture. This mixture is then stirred for 10 minutes and adjusted using deionized water and dimethylethanolamine to a pH of 8 and to a spray viscosity of 90±5 mPa·s under a shearing load of 1000 s⁻¹, as measured using a rotary viscometer (Rheolab QC instrument with C-LTD80/QC heating system from Anton Paar) at 23° C.

TABLE D
Preparation of waterborne basecoat
materials WBM B11 and WBM B12

| | |
|---|---|
| WBM B11 | WBM B12 |

Aqueous phase:

| | | |
|---|---|---|
| 3% Na—Mg phyllosilicate | 4.20 | |
| solution | | |
| (vdM) 5 | | 8.20 |
| Deionized water | 6.36 | 4.57 |
| Butyl glycol | 4.00 | 4.00 |
| 2-Ethylhexanol | 3.55 | 3.55 |
| Aqueous dispersion of | 13.96 | 13.96 |
| poly(meth)acrylate emulsion | | |
| polymer having a nonvolatile | | |
| fraction of 26-28% | | |
| Polyester; prepared as per | 4.85 | 3.01 |
| example D, column 16, line | | |
| 37-59 of DE 40 09 858 A1 | | |
| Deionized water | 4.20 | |
| 30 wt % aqueous Rheovis ® AS 1130 | 0.42 | |
| solution, available from BASF SE | | |
| Melamine-formaldehyde resin | 7.70 | 7.70 |
| (Cymel ® 203 from Allnex) | | |
| 2,4,7,9-Tetramethyl-5-decynediol, | 1.80 | 1.65 |
| 52% in BG (available from BASF SE) | | |
| 10% dimethylethanolamine in water | 1.08 | 0.88 |
| Pluriol ® P900, available from BASF SE | 0.10 | 0.10 |
| Triisobutyl phosphate | 2.50 | 2.50 |
| White paste | 51.90 | 51.90 |
| Yellow paste | 0.12 | 0.12 |
| Black paste | 0.11 | 0.11 |
| Steatite paste | 2.40 | 2.40 |

Preparation of White Paste

The white paste is prepared from 34 parts by weight of titanium rutile R 2310, 43.3 parts by weight of an aqueous dispersion of a poly(meth)acrylate emulsion polymer having a nonvolatile fraction of 26-28%, 3.9 percent by weight of butylglycol, 16.7 parts by weight of deionized water and 2.1 parts by weight of Disperbyk®-184 (available from BYK-Chemie GmbH).

Preparation of Yellow Paste

The yellow paste is prepared from 47 parts by weight of Sicotan Yellow L 1912, 45 parts by weight of an aqueous binder dispersion prepared as per WO 91/15528, page 23, line 26 to page 25, line 24, 2.7 percent by weight of 1-propoxy-2-propanol, 2.8 parts by weight of deionized water, 1.5 parts by weight of Disperbyk®-184 (available from BYK-Chemie GmbH), and 1 part by weight of Aerosil R 972 (available from Evonik Industries).

Preparation of Black Paste

The black paste is prepared from 40 parts by weight of Bayferrox 318 M (available from Lanxess), 39 parts by weight of an aqueous binder dispersion prepared as per WO 91/15528, page 23, line 26 to page 25, line 24, 2.0 percent by weight of 1-propoxy-2-propanol, 11.1 parts by weight of deionized water, 0.5 part by weight of Agitan 282 (available from Münzing Chemie GmbH), 4.4 parts by weight of Pluriol® P900 (available from BASF SE) and 3 parts by weight of 10% dimethylethanolamine in water.

Preparation of Steatite Paste

The steatite paste is prepared from 49.7 parts by weight of an aqueous binder dispersion prepared as per WO 91/15528, page 23, line 26 to page 25, line 24, 28.9 parts by weight of steatite (Microtalc IT extra from Mondo Minerals B.V.), 0.4 part by weight of Agitan 282 (available from Münzing Chemie GmbH), 1.45 parts by weight of Disperbyk®-184 (available from BYK-Chemie GmbH), 3.1 parts by weight of a commercial polyether (Pluriol® P900, available from BASF SE) and 16.45 parts by weight of deionized water.

1.2E Preparation of Aqueous Basecoat Materials WBM B13 (Comparative) and WBM B14 (Inventive)

The components listed under “Aqueous phase” in table E are combined with stirring in the order stated to form an aqueous mixture. This mixture is then stirred for 10 minutes and adjusted using deionized water and dimethylethanolamine to a pH of 8 and to a spray viscosity of 85±5 mPa·s under a shearing load of 1000 s⁻¹, as measured using a rotary viscometer (Rheolab QC instrument with C-LTD80/QC heating system from Anton Paar) at 23° C.

TABLE E
Preparation of waterborne basecoat
materials WBM B13 and WBM B14

| | |
|---|---|
| WBM | WBM |
| B13 | B14 |

Aqueous phase:

| | | |
|---|---|---|
| 3% Na—Mg phyllosilicate | 15.23 | |
| solution | | |
| (vdM) 5 | | 20.00 |
| 1-Propoxy-2-propanol | 1.41 | 1.41 |
| 2-Ethylhexanol | 0.87 | 0.87 |
| Aqueous dispersion of | 18.13 | 18.13 |
| poly(meth)acrylate emulsion | | |
| polymer having a nonvolatile | | |
| fraction of 26-28% | | |
| Polyester; prepared as per | 6.00 | 2.50 |
| example D, column 16, | | |
| line 37-59 of DE 40 09 858 A1 | | |
| Melamine-formaldehyde resin | 5.44 | 5.44 |
| (Resimene ® HM 2608 from Ineos) | | |
| 10% Dimethylethanolamine in | 0.60 | 0.30 |
| water | | |
| 2,4,7,9-Tetramethyl-5-decynediol, | 1.09 | 1.09 |
| 52% in BG (available from BASF SE) | | |
| Butyl glycol | 4.35 | 4.35 |
| Isopar ® L, available from Exxon Mobil | 1.84 | 1.84 |
| Hydrosol A170, available from DHC | 0.54 | 0.54 |
| Solvent Chemie GmbH | | |
| Pluriol ® P900, available from BASF SE | 1.63 | 1.63 |
| Triisobutyl phosphate | 0.80 | 0.80 |
| Tinuvin ® 384-2, available from BASF SE | 0.40 | 0.40 |
| Tinuvin ® 123, available from BASF SE | 54.31 | 54.31 |
| White paste | 0.12 | 0.12 |
| Yellow paste | 0.11 | 0.11 |
| Black paste | 2.23 | 2.23 |
| Steatite paste | | |

Preparation of White Paste

The white paste is prepared from 34 parts by weight of titanium rutile R 2310, 43.3 parts by weight of an aqueous dispersion of a poly(meth)acrylate emulsion polymer having a nonvolatile fraction of 26-28%, 3.9 percent by weight of butylglycol, 16.7 parts by weight of deionized water and 2.1 parts by weight of Disperbyk®-184 (available from BYK-Chemie GmbH).

Preparation of Yellow Paste

The yellow paste is prepared from 47 parts by weight of Sicotan Yellow L 1912, 45 parts by weight of an aqueous binder dispersion prepared as per WO 91/15528, page 23, line 26 to page 25, line 24, 2.7 percent by weight of 1-propoxy-2-propanol, 2.8 parts by weight of deionized water, 1.5 parts by weight of Disperbyk®-184 (available from BYK-Chemie GmbH), and 1 part by weight of Aerosil R 972 (available from Evonik Industries).

Preparation of Black Paste

The black paste is prepared from 57 parts by weight of a polyurethane dispersion prepared as per WO 92/15405, page 13, line 13 to page 15, line 13, 10 parts by weight of carbon black (Monarch® 1400 carbon black from Cabot Corporation), 5 parts by weight of a polyester prepared as per example D, column 16, lines 37-59 of DE 40 09 858 A1, 6.5 parts by weight of a 10% strength aqueous dimethylethanolamine solution, 2.5 parts by weight of a commercial polyether (Pluriol® P900, available from BASF SE), 7 parts by weight of butyl diglycol, and 12 parts by weight of deionized water.

Preparation of Steatite Paste

The steatite paste is prepared from 49.7 parts by weight of an aqueous binder dispersion prepared as per WO 91/15528, page 23, line 26 to page 25, line 24, 28.9 parts by weight of steatite (Microtalc IT extra from Mondo Minerals B.V.), 0.4 part by weight of Agitan 282 (available from Münzing Chemie GmbH), 1.45 parts by weight of Disperbyk®-184 (available from BYK-Chemie GmbH), 3.1 parts by weight of a commercial polyether (Pluriol® P900, available from BASF SE) and 16.45 parts by weight of deionized water.

1.2F Preparation of Aqueous Basecoat Materials WBM B15 (Comparative) and WBM B16 (Inventive)

The components listed under “Aqueous phase” in table F are combined with stirring in the order stated to form an aqueous mixture. This mixture is then stirred for 10 minutes and adjusted using deionized water and dimethylethanolamine to a pH of 8 and to a spray viscosity of 110±10 mPa·s (WBM 15) or 140±10 mPa·s (WBM B16) under a shearing load of 1000 s⁻¹, as measured using a rotary viscometer (Rheolab QC instrument with C-LTD80/QC heating system from Anton Paar) at 23° C.

TABLE F
Preparation of waterborne basecoat
materials WBM B15 and WBM B16

| | |
|---|---|
| WBM | WBM |
| B15 | B16 |

Aqueous phase:

| | | |
|---|---|---|
| 3% Na—Mg phyllosilicate | 13.10 | |
| solution | | |
| (vdM) 4 | | 14.65 |
| Deionized water | 10.53 | 16.33 |
| n-Propanol | 0.87 | 0.87 |
| n-butoxypropano1 | 1.38 | 1.38 |
| 2-Ethylhexanol | 2.77 | 2.77 |
| Aqueous dispersion of | 35.24 | 35.24 |
| poly(meth)acrylate emulsion | | |
| polymer having a nonvolatile | | |
| fraction of 26-28% | | |
| Polyester; prepared as per | 2.95 | |
| example D, column 16, line | | |
| 37-59 of DE 40 09 858 A1 | | |
| Melamine-formaldehyde resin | 4.10 | |
| (Resimene ® HM 2608 from Ineos) | | |
| 10% Dimethylethanolamine in | 0.30 | |
| Water | | |
| 2,4,7,9-Tetramethyl-5-decynediol, | 1.38 | 1.38 |
| 52% in BG (available from BASF SE) | | |
| BYK-346, available from | 0.46 | 0.46 |
| Altana/BYK-Chemie GmbH | | |
| Polyurethane-modified polyacrylate; | 2.77 | 2.77 |
| prepared as per page 7, line 55 to | | |
| page 8, line 23 of DE 4437535 A1 | | |
| Isopropanol | 1.64 | 1.64 |
| Butyl glycol | 1.00 | 1.00 |
| Isopar ® L, available from Exxon Mobil | 0.87 | 0.87 |
| NACURE 2500, available from | 0.42 | 0.42 |
| King Industries, Inc | | |
| Black paste | 12.99 | 12.99 |
| Blue paste | 0.78 | 0.78 |
| Barium sulfate paste | 3.21 | 3.21 |
| Steatite paste | 3.25 | 3.25 |

Preparation of Black Paste

The black paste is prepared from 57 parts by weight of a polyurethane dispersion prepared as per WO 92/15405, page 13, line 13 to page 15, line 13, 10 parts by weight of carbon black (Monarch® 1400 carbon black from Cabot Corporation), 5 parts by weight of a polyester prepared as per example D, column 16, lines 37-59 of DE 40 09 858 A1, 6.5 parts by weight of a 10% strength aqueous dimethylethanolamine solution, 2.5 parts by weight of a commercial polyether (Pluriol® P900, available from BASF SE), 7 parts by weight of butyl diglycol, and 12 parts by weight of deionized water.

Preparation of Blue Paste

The blue paste was prepared from 69.8 parts by weight of a polyurethane dispersion prepared as per WO 92/15405, page 13, line 13 to page 15, line 13, 12.5 parts by weight of Paliogen® Blue L 6482 (available from BASF SE), 1.5 parts by weight of 10% strength aqueous dimethylethanolamine solution, 1.2 parts by weight of a commercial polyether (Pluriol® P900, available from BASF SE), and 15 parts by weight of deionized water.

Preparation of Barium Sulfate Paste

The barium sulfate paste is prepared from 39 parts by weight of a polyurethane dispersion prepared as per EP 0228003 B2, page 8, lines 6 to 18, 54 parts by weight of barium sulfate (Blanc fixe micro from Sachtleben Chemie GmbH), 3.7 parts by weight of butyl glycol, and 0.3 part by weight of Agitan 282 (available from Münzing Chemie GmbH), and 3 parts by weight of deionized water.

Preparation of Steatite Paste

The steatite paste is prepared from 49.7 parts by weight of an aqueous binder dispersion prepared as per WO 91/15528, page 23, line 26 to page 25, line 24, 28.9 parts by weight of steatite (Microtalc IT extra from Mondo Minerals B.V.), 0.4 part by weight of Agitan 282 (available from Münzing Chemie GmbH), 1.45 parts by weight of Disperbyk®-184 (available from BYK-Chemie GmbH), 3.1 parts by weight of a commercial polyether (Pluriol® P900, available from BASF SE) and 16.45 parts by weight of deionized water.

1.2G Preparation of Aqueous Basecoat Materials WBM B17 (Comparative) and WBM B18 (Inventive)

The components listed under “Aqueous phase” in table G are combined with stirring in the order stated to form an aqueous mixture. In the next step, an organic mixture is prepared from the components listed under “Organic phase” in table G, and a mixing varnish is prepared from the components listed under “Mixing varnish”. The organic mixture and the mixing varnish are mixed for 10 minutes, and this mixture is then added to the aqueous mixture. The resulting mixture is then stirred for 10 minutes and adjusted using deionized water and dimethylethanolamine to a pH of 8 and to a spray viscosity of 85±5 mPa·s under a shearing load of 1000 s⁻¹, as measured using a rotary viscosimeter (Rheolab QC instrument with C-LTD80/QC heating system from Anton Paar) at 23° C.

TABLE G
Preparation of waterborne basecoat
materials WBM B17 and WBM B18

| | |
|---|---|
| WBM | WBM |
| B17 | B18 |

Aqueous phase:

| | | |
|---|---|---|
| Deionized water | 16.48 | 29.34 |
| Butyl glycol | 5.78 | |
| (vdM) 6 | 22.96 | |
| Disparlon ® A670-20M (direction | | 3.44 |
| addition) | | |
| Aqueous dispersion of a | 32.26 | |
| poly(meth)acrylate emulsion | | |
| polymer having a nonvolatile | | |
| fraction of 26-28% | | |
| Polyester; prepared as for | | 5.17 |
| example D, column 16, | | |
| lines 37-59 of DE 40 09 858 A1 | | |
| Dimethylethanolamine in water | 0.80 | 0.91 |
| (10 wt %) | | |
| Rheovis ® AS 1130 | 0.75 | |
| 2,4,7,9-Tetramethyl-5-decynediol | | 0.69 |
| in butyl glycol (52 wt %) | | |
| Resimene ® HM 2608 | 4.36 | |
| Pluriol ® P900 | 1.15 | |

Organic phase:

| | | |
|---|---|---|
| Butyl glycol | 6.89 | 6.89 |
| Alu Stapa Hydrolux ® VP56450 | 5.74 | 5.74 |

Mixing varnish:

| | | |
|---|---|---|
| Aqueous dispersion of a | 1.89 | 1.89 |
| poly(meth)acrylate emulsion | | |
| polymer having a nonvolatile | | |
| fraction of 26-28% | | |
| Deionized water | 1.17 | 1.17 |
| 2,4,7,9-Tetramethyl-5-decynediol | 0.24 | 0.24 |
| in butyl glycol (52 wt %) | | |
| Dispex ® Ultra FA 4437 | 0.10 | 0.10 |
| Dimethylethanolamine in water | 0.01 | 0.01 |
| (10 wt %) | | |
| Butyl glycol | 0.60 | 0.60 |

2. Investigation of Basecoat Materials and Multicoat Paint Systems Produced Using Basecoat Materials

Comparison Between Waterborne Basecoat Material WBM B2 and Waterborne Basecoat Materials WBM B1 and Also WBM B3 to WBM B6

Investigation took place into the incidence of gel specks, the tendency toward separation, and the film thickness-dependent leveling. The results are summarized in tables 2.1 and 2.2.

TABLE 2.1
Results of the investigations into stability
(separation) and gel specks

| | WBM | WBM | WBM | WBM | WBM | WBM |
|---|---|---|---|---|---|---|
| | B1 | B2 | B3 | B4 | B5 | B6 |
| Stability (visual | 1 | 1 | 4 | 3 | 5 | 4 |
| assessment of | | | | | | |
| separation) | | | | | | |
| Gel specks | 1 | 1 | 3 | 4 | 5 | 4 |
| (coating on | | | | | | |
| glass panel) | | | | | | |
| Gel specks | 1 | 1 | 3 | 4 | 5 | 4 |
| (coating on | | | | | | |
| steel substrate) | | | | | | |

WBM B1 (containing phyllosilicate) and WBM B2 (for inventive use) have no gel specks and also show no tendency toward phase or other separation. The basecoat materials with polyamides having a high acid number (WBM B3 to WBM B6) surprisingly display significant weaknesses in gel specks and stability; increasing the amount of the polyamide does not produce any improvement. These polyamides are therefore much poorer for use as rheological assistants in waterborne basecoat materials. The reference used for the further investigations was therefore the system containing phyllosilicate.

TABLE 2.2
Results of the investigations into
leveling (here: SW, LW, and DOI)

| | | Paint system 1st Waterborne | |
|---|---|---|---|
| | | basecoat as wedge | |
| | | WBM | WBM |
| | | A2 | A2 |
| | | Paint system 2nd Waterborne | |
| | | basecoat constant | |
| Appearance | Film thickness range 2nd | WBM | WBM |
| characteristic | basecoat | B1 | B2 |
| SW | 5 μm-10 μm | 20.2 | 16.3 |
| | 10 μm-15 μm | 19.2 | 17.6 |
| | 15 μm-20 μm | 20.6 | 20.3 |
| | 20 μm-25 μm | 21.9 | 21.0 |
| | 25 μm-30 μm | 22.6 | 22.6 |
| LW | 5 μm-10 μm | 8.7 | 8.9 |
| | 10 μm-15 μm | 9.6 | 9.3 |
| | 15 μm-20 μm | 10.5 | 8.6 |
| | 20 μm-25 μm | 11.2 | 10.0 |
| | 25 μm-30 μm | 11.6 | 10.7 |
| DOI | 5 μm-10 μm | 90.9 | 93.7 |
| | 10 μm-15 μm | 91.6 | 92.6 |
| | 15 μm-20 μm | 91.6 | 90.6 |
| | 20 μm-25 μm | 89.5 | 90.2 |
| | 25 μm-30 μm | 90.0 | 88.4 |

The results demonstrate that by using a basecoat material for inventive use it is possible to exert a positive influence on leveling, especially at relatively low to moderate film thicknesses.

Comparison Between Waterborne Basecoat Materials WBM B7 and WBM B9 and Also Waterborne Basecoat Materials WBM B8 and WBM B10

Investigation took place into the incidence of pinholes and the film thickness-dependent leveling. The results are summarized in tables 2.3 to 2.5.

TABLE 2.3
Results of the investigations into pinholes
Number of pinholes (standardized to 200 cm²):

| | Paint system 1st waterborne | | | |
|---|---|---|---|---|
| | basecoat as wedge | | | |
| | WBM | WBM | WBM | WBM |
| | A2 | A2 | A2 | A2 |
| Film thickness range basecoat | Paint system 2nd waterborne | | | |
| total film (waterborne | basecoat constant | | | |
| basecoat 1 + waterborne | WBM | WBM | WBM | WBM |
| basecoat 2) | B7= | B8 | B9 | B10 |
| 0-20 μm | 0 | 0 | 0 | 0 |
| 20 μm-end of wedge | 0 | 0 | 0 | 0 |
| Total | 0 | 0 | 0 | 0 |

Number of pinholes (standardized to 200 cm²):

| | Paint system 1st Waterborne | | | |
|---|---|---|---|---|
| | basecoat constant | | | |
| | WBM | WBM | WBM | WBM |
| | A2 | A2 | A2 | A2 |
| Film thickness range basecoat | Paint system 2nd Waterborne | | | |
| total film (waterborne | basecoat as wedge | | | |
| basecoat 1 + waterborne | WBM | WBM | WBM | WBM |
| basecoat 2) | B7= | B8 | B9 | B10 |
| 0-20 μm | 0 | 0 | 0 | 0 |
| 20 μm-end of wedge | 0 | 0 | 1 | 0 |
| Total | 0 | 0 | 1 | 0 |

Waterborne basecoat materials WBM B7 to WBM B10 consistently show very good pinhole robustness.

TABLE 2.4
Results of the investigations into leveling (here: SW, LW
and DOI of waterborne basecoat materials WBM B7 and WBM B8)

| | | Paint system 1st Waterborne | |
|---|---|---|---|
| | | basecoat as wedge | |
| | | WBM | WBM |
| | | A2 | A2 |
| | | Paint system 2nd Waterborne | |
| | | basecoat constant | |
| Appearance | Film thickness range 2nd | WBM | WBM |
| characteristic | basecoat | B7 | B8 |
| SW | 5 μm-10 μm | 22.0 | 16.0 |
| | 10 μm-15 μm | 20.3 | 16.2 |
| | 15 μm-20 μm | 20.0 | 17.1 |
| | 20 μm-25 μm | 21.9 | 19.2 |
| | 25 μm-30 μm | 22.4 | 20.4 |
| LW | 5 μm-10 μm | 8.2 | 8.4 |
| | 10 μm-15 μm | 7.2 | 7.5 |
| | 15 μm-20 μm | 7.6 | 6.8 |
| | 20 μm-25 μm | 8.7 | 7.8 |
| | 25 μm-30 μm | 9.5 | 8.9 |
| DOI | 5 μm-10 μm | 91.6 | 91.4 |
| | 10 μm-15 μm | 91.2 | 92.3 |
| | 15 μm-20 μm | 90.8 | 92.0 |
| | 20 μm-25 μm | 89.8 | 91.3 |
| | 25 μm-30 μm | 88.9 | 91.5 |

TABLE 2.5
Results of the investigations into leveling (here: LW
of waterborne basecoat materials WBM B9 and WBM B10)

| | | Paint system 1st Waterborne | |
|---|---|---|---|
| | | basecoat as wedge | |
| | | WBM | WBM |
| | | A1 | A1 |
| | | Paint system 2nd Waterborne | |
| | | basecoat constant | |
| Appearance | Film thickness range 2nd | WBM | WBM |
| characteristic | basecoat | B9 | B10 |
| LW | 5 μm-10 μm | 9.2 | 7.6 |
| | 10 μm-15 μm | 9.6 | 7.4 |
| | 15 μm-20 μm | 9.1 | 7.7 |
| | 20 μm-25 μm | 10.2 | 8.1 |
| | 25 μm-30 μm | 11.5 | 8.9 |

The results demonstrate that by using the inventive waterborne basecoat materials WBM B8 and WBM B10 it is possible to optimize the leveling.

Comparison Between Waterborne Basecoat Materials WBM B11 and WBM B12

Investigation took place into the storage stability and the film thickness-dependent leveling. The results are summarized in tables 2.6 and 2.7.

TABLE 2.6
Results of the investigations into storage stability

Waterborne basecoat
material

| | | WBM | WBM |
|---|---|---|---|
| | | B11 | B12 |
| Low-shear | Fresh after 2-week | 3398.5 | 2456.7 |
| viscosity | storage at 40° C. | 2811.2 | 2300 |
| (1 s⁻¹) | change [%] | −17% | −6% |
| in mPa · s | | | |
| High-shear | Fresh after 2-week | 95.43 | 92.7 |
| viscosity | storage at 40° C. | 85.59 | 81.97 |
| (1000 s⁻¹) | change [%] | −10% | −12% |
| in mPa · s | | | |

As far as the change in the high-shear viscosity is concerned, the behavior exhibited by both basecoat materials is comparable. When a basecoat for inventive use is used that comprises a mixture (vdM) comprising a polyamide with low acid number (WBM B12), a significant advantage is evident over the reference (WBM B11) in terms of the change in low-shear viscosity.

TABLE 2.5
Results of the investigations into film thickness-
dependent leveling (here: LW/DOI)

| | | Paint system 1st Waterborne | |
|---|---|---|---|
| | | basecoat as wedge | |
| | | WBM | WBM |
| | | A2 | A2 |
| | | Paint system 2nd Waterborne | |
| | | basecoat constant | |
| Appearance | Film thickness range 2nd | WBM | WBM |
| characteristic | basecoat | B11 | B12 |
| LW | 10 μm-15 μm | 13.5 | 12.3 |
| | 15 μm-20 μm | 13.0 | 11.8 |
| | 20 μm-25 μm | 12.9 | 11.3 |
| | 25 μm-30 μm | 13.1 | 12.4 |
| DOI | 10 μm-15 μm | 77.7 | 80.7 |
| | 15 μm-20 μm | 74.3 | 79.7 |
| | 20 μm-25 μm | 71.3 | 77.0 |
| | 25 μm-30 μm | 71.7 | 73.0 |

The results emphasize that when using a polyamide of the invention with a low acid number it is possible in all film thickness ranges to achieve better leveling (determined in this case were only LW and DOI).

Comparison Between Waterborne Basecoat Materials WBM B13 and WBM B14

Investigation took place into the film thickness-dependent leveling. The results are summarized in table 2.8.

TABLE 2.8
Results of the investigations into film thickness-
dependent leveling (here: SW/LW/DOI)

| | | Paint system 1^{st} Waterborne | |
|---|---|---|---|
| | | basecoat as wedge | |
| | | WBM | WBM |
| | | A2 | A2 |
| | | Paint system 2nd Waterborne | |
| | | basecoat constant | |
| Appearance | Film thickness range 2^{nd} | WBM | WBM |
| characteristic | basecoat | B13 | B14 |
| SW | 10 μm-15 μm | 31.1 | 22.2 |
| | 15 μm-20 μm | 32.8 | 25.1 |
| | 20 μm-25 μm | 34.0 | 28.5 |
| | 25 μm-30 μm | 35.6 | 30.5 |
| LW | 10 μm-15 μm | 11.1 | 10.0 |
| | 15 μm-20 μm | 11.5 | 10.2 |
| | 20 μm-25 μm | 12.6 | 9.6 |
| | 25 μm-30 μm | 15.1 | 10.3 |
| DOI | 10 μm-15 μm | 70.6 | 82.4 |
| | 15 μm-20 μm | 68.3 | 79.0 |
| | 20 μm-25 μm | 63.7 | 76.2 |
| | 25 μm-30 μm | 60.3 | 73.4 |

The use of a basecoat for inventive use, comprising a predispersed mixture comprising a polyamide with low acid number (WBM B14), in comparison to the phyllosilicate-containing reference (WBM B13), leads to a significant improvement in the leveling, particularly the short wave, and also the DOI.

Comparison Between Waterborne Basecoat Materials WBM B15 and WBM B16

Investigation took place into the pinhole robustness and the film thickness-dependent leveling. The results are summarized in tables 2.9 to 2.11.

TABLE 2.9
Results of the investigations into pinholes
Number of pinholes (standardized to 200 cm²):

Paint system 1st waterborne
basecoat as wedge

| | |
|---|---|
| WBM | WBM |
| A1 | A1 |

| | |
|---|---|
| Film thickness range basecoat | Paint system 2nd waterborne |
| total film (waterborne | basecoat constant |

| basecoat 1 + waterborne | WBM | WBM |
|---|---|---|
| basecoat 2) | 15 | 16 |
| 0-20 μm | 10 | 1 |
| 20 μm-end of wedge | 24 | 1 |
| Total | 34 | 2 |

Number of pinholes (standardized to 200 cm²):

Paint system 1st waterborne
basecoat constant

| | |
|---|---|
| WBM | WBM |
| A1 | A1 |

| | |
|---|---|
| Film thickness range basecoat | Paint system 2nd waterborne |
| total film (waterborne | basecoat as wedge |

| basecoat 1 + waterborne | WBM | WBM |
|---|---|---|
| basecoat 2) | 15 | 16 |
| 0-20 μm | 63 | 0 |
| 20 μm-end of wedge | 21 | 0 |
| Total | 84 | 0 |

The waterborne basecoat material WBM B16 for inventive use has a significantly better pinhole robustness than the phyllosilicate-based waterborne basecoat material WBM B15.

TABLE 2.10
Results of the investigations into pinholes
Number of pinholes (standardized to 200 cm²):

Paint system 1st waterborne
basecoat as wedge

| | |
|---|---|
| WBM | WBM |
| A2 | A2 |

| | |
|---|---|
| Film thickness range basecoat | Paint system 2nd waterborne |
| total film (waterborne | basecoat constant |

| basecoat 1 + waterborne | WBM | WBM |
|---|---|---|
| basecoat 2) | 15 | 16 |
| 0-20 μm | 7 | 0 |
| 20 μm-end of wedge | 2 | 0 |
| Total | 9 | 0 |

Number of pinholes (standardized to 200 cm²):

Paint system 1st waterborne
basecoat constant

| | |
|---|---|
| WBM | WBM |
| A2 | A2 |

| | |
|---|---|
| Film thickness range basecoat | Paint system 2nd waterborne |
| total film (waterborne | basecoat as wedge |

| basecoat 1 + waterborne | WBM | WBM |
|---|---|---|
| basecoat 2) | 15 | 16 |
| 0-20 μm | 7 | 0 |
| 20 μm-end of wedge | 0 | 0 |
| Total | 7 | 0 |

When using WBM A2 as first waterborne basecoat material, a significantly lower pinhole level is found for the phyllosilicate-containing reference (WBM B15); slight advantages are nevertheless still apparent when using the basecoat material for inventive use WBM B16.

TABLE 2.11
Results of the investigations into leveling (here: SW, LW and DOI)

| | | Paint system 1^{st} Waterborne | |
|---|---|---|---|
| | | basecoat as wedge | |
| | | WBM | WBM |
| | | A1 | A1 |
| | | Paint system 2nd Waterborne | |
| | | basecoat constant | |
| Appearance | Film thickness range 2^{nd} | WBM | WBM |
| characteristic | basecoat | B15 | B16 |
| SW | 10 μm-20 μm | 23.4 | 23.8 |
| | 20 μm-30 μm | 27.5 | 26.4 |
| | 30 μm-40 μm | 34.6 | 28.6 |
| LW | 10 μm-20 μm | 5.5 | 4.9 |
| | 20 μm-30 μm | 6.6 | 5.6 |
| | 30 μm-40 μm | 8.2 | 6.2 |
| DOI | 10 μm-20 μm | 87.3 | 88.0 |
| | 20 μm-30 μm | 82.5 | 86.2 |
| | 30 μm-40 μm | 74.8 | 85.7 |

The results emphasize that advantages are achieved for the systems of the invention in terms of leveling as well, particularly over high film thicknesses.

Comparison Between Waterborne Basecoat Materials WBM B17 and WBM B18

Investigation took place into the incidence of gel specks and the storage stability. The results are summarized in tables 2.12 and 2.13.

TABLE 2.12
Results of the investigations into gel specks

| | WBM | WBM |
|---|---|---|
| | B17 | B18 |
| Gel specks | 1 | 5 |
| (coating on | | |
| glass panel) | | |
| Gel specks | 1 | 5 |
| (coating on | | |
| steel substrate) | | |

TABLE 2.13
Results of the investigations into storage stability

Waterborne basecoat
material

| | | WBM | WBM |
|---|---|---|---|
| | | B17 | B18 |
| Low-shear | Fresh after 2-week | 3053 | n.m. |
| viscosity | storage at 40° C. | 3177 | n.m. |
| (1 s⁻¹) | change [%] | 4% | n.m. |
| in mPa · s | | | |
| High-shear | Fresh after 2-week | 79 | n.m. |
| viscosity | storage at 40° C. | 85 | n.m. |
| (1000 s⁻¹) | change [%] | 6% | n.m. |
| in mPa · s | | | |

The results show that the basecoat material for inventive use WBM B17 has excellent quality in the area of storage stability and formation of gel specks. In particular it is apparent that the use of a basecoat material WBM B18, which contains the same polyamide with low acid number as WBM B17, but in which the polyamide has been introduced directly and not in the form of the predispersed mixture (vdM), gives much poorer properties.

All in all, results show that the use of a polyamide of low acid number in waterborne basecoat materials leads, surprisingly, to much better properties than does the use of polyamides of higher acid number which are actually intended for aqueous coating systems. These advantages, however, are obtained only when the polyamide of low acid number is introduced in the form of predispersed mixture (vdM) into the aqueous basecoat material.

### BRIEF DESCRIPTION OF THE FIGURES

FIG. 1:

Schematic construction of a multicoat paint system of the invention (M), disposed on a metallic substrate (S), and comprising a cured electrocoat (E.1) and also a basecoat (B.2.1) and a clearcoat (K) which have been jointly cured.

FIG. 2:

Schematic construction of a multicoat paint system of the invention (M), disposed on a metallic substrate (S), and comprising a cured electrocoat (E.1), two basecoats (B.2.2.x), namely a first basecoat (B.2.2.a) and a topmost basecoat (B.2.2.z) arranged over it, and also a clearcoat (K), which have been jointly cured.

FIG. 3:

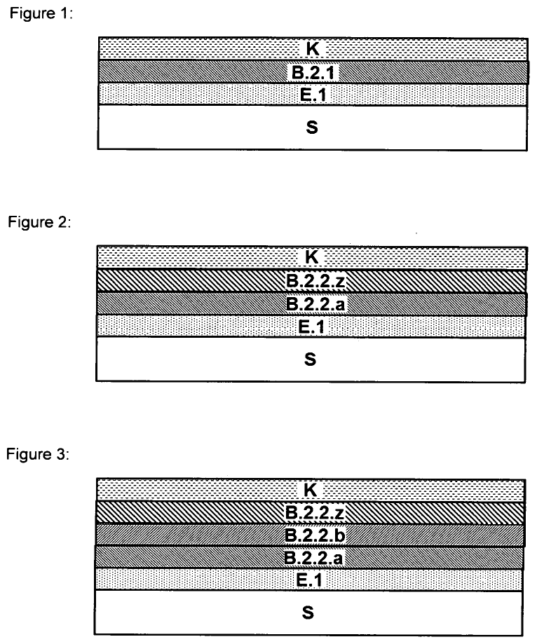

Schematic construction of a multicoat paint system of the invention (M), disposed on a metallic substrate (S), and comprising a cured electrocoat (E.1), three basecoats (B.2.2.x), namely a first basecoat (B.2.2.a), a basecoat (B.2.2.b), and a topmost basecoat (B.2.2.z), arranged over it, and also a clearcoat (K), which have been jointly cured.

1. A method for producing a multicoat paint system on a metallic substrate, comprising:
(1) producing a cured electrocoat on the metallic substrate by electrophoretic application of an electrocoat material to the substrate and subsequent curing of the electrocoat material,
(2) producing a basecoat or two or more directly successive basecoats directly on the cured electrocoat by application of an aqueous basecoat material directly to the cured electrocoat or directly successive application of two or more basecoat materials to the cured electrocoat,
(3) producing a clearcoat directly on the basecoat or on a topmost basecoat by application of a clearcoat material directly to the basecoat or to the topmost basecoat,
(4) jointly curing the basecoat and the clearcoat or the basecoats and the clearcoat,
wherein
the aqueous basecoat material or at least one of the basecoat materials comprises at least one predispersed mixture, the at least one predispersed mixture comprising at least one polyamide having an acid number of less than 20 mg KOH/g, at least one polymeric resin different from the at least one polyamide, and also water and at least one organic solvent.

2. The method as claimed in claim 1, wherein the at least one polyamide has an acid number of less than 15 mg KOH per g.

3. The method as claimed in claim 1, wherein the at least one polyamide has an acid number of 0.1 to less than 15.0 mg KOH per g.

4. The method as claimed in claim 1, wherein a relative weight ratio of the at least one polymeric resin to the at least one polyamide in the at least one predispersed mixture is in a range from 15:1 to 2.0:1.

5. The method as claimed in claim 1, wherein a fraction of the at least one predispersed mixture based on a total amount of the aqueous basecoat material or of the at least one basecoat material, is 5 to 30 wt %, the at least one polyamide being present in a fraction of 0.15 to 3.0 wt %, based on the total amount of the aqueous basecoat material or of the at least one basecoat material.

6. The method as claimed in claim 1, wherein the at least one polymeric resin in the at least one predispersed mixture comprises at least one polyester, the polyester having an acid number of 20 to 50 mg KOH per g and an OH number of 20 to 300 mg KOH per g.

7. The method as claimed in claim 1, wherein the aqueous basecoat material or at least one of the basecoat materials, comprises at least one polymer as binder, different from the at least one polymeric resin and selected from the group consisting of hydroxy-functional polyurethanes, polyesters, polyacrylates, and copolymers of these polymers.

8. The method as claimed in claim 1, wherein the aqueous basecoat material or at least one of the basecoat materials, comprises at least one melamine resin as crosslinking agent.

9. The method as claimed in claim 1, wherein the aqueous basecoat material or at least one of the basecoat materials, are one-component coating compositions.

10. The method as claimed in claim 1, wherein the jointly curing (4) is carried out at temperatures of 100 to 250° C. for a time of 5 to 60 min.

11. The method as claimed in claim 1, wherein a percentage sum of a solids content and a fraction of water of the aqueous basecoat material or of at least one of the basecoat materials is at least 70 wt %.

12. The method as claimed in claim 1, wherein the at least one predispersed mixture comprises at least one emulsifier selected from the group consisting of lecithinens and C₁₂-C₂₄ fatty alcohol polyglycol ethers.

13. The method as claimed in claim 1, wherein the at least one polyamide has a number-average molecular weight in a range from 250 g/mol to 3000 g/mol.

14. The method as claimed in claim 1, wherein an automobile body is used as the metallic substrate.

15. A multicoat paint system produced by the method as claimed in claim 1.

16. The method as claimed in claim 1, wherein the aqueous basecoat material or all of the basecoat materials comprise at least one polymer as binder, different from the at least one polymeric resin and selected from the group consisting of hydroxy-functional polyurethanes, polyesters, polyacrylates, and copolymers of these polymers.

17. The method as claimed in claim 1, wherein the aqueous basecoat material or all of the basecoat materials comprise at least one melamine resin as crosslinking agent.

18. The method as claimed in claim 1, wherein the aqueous basecoat material or all of the basecoat materials are one-component coating compositions.

19. The method as claimed in claim 11, wherein the percentage sum of the solids content and the fraction of water of the aqueous basecoat material or of at least one of the basecoat materials is 80 to 90 wt %.

20. The method as claimed in claim 11, wherein the percentage sum of the solids content and the fraction of water of the aqueous basecoat material or of all of the basecoat materials is 80 to 90 wt %.
